(19) United States
(12) Patent Application Publication
(10) Pub. No.: US 2011/0313936 A1
(43) Pub. Date: Dec. 22, 2011

(54) METHOD AND APPARATUS FOR ESTIMATING VALUE OF A DAMAGED VEHICLE

(76) Inventor: Joseph Michael Sieger, Barrington, IL (US)

(21) Appl. No.: 13/162,844

(22) Filed: Jun. 17, 2011

Related U.S. Application Data
(60) Provisional application No. 61/356,273, filed on Jun. 18, 2010.
(60) Provisional application No. 61/357,718, filed on Jun. 23, 2010.
(60) Provisional application No. 61/366,661, filed on Jul. 22, 2010.

(51) Int. Cl. G06Q 30/00

(52) U.S. Cl. 705/306; 705/330

(57) ABSTRACT

A method and apparatus by which a user who wishes to sell a used or damaged vehicle inputs information about the vehicle including make, model and year. The user is shown images of similar vehicles with various degrees of damage and is shown a purchase price at each level of damage. The purchase prices for the displayed vehicles are calculated to include auction price of the vehicle, regional price differences, title transfer costs, towing costs, etc. By selecting an image of a vehicle with damage as the vehicle to be sold, the user may sell the vehicle at that price. An agent embodiment shows images, prices and percentiles of damaged vehicles at different damage levels so that the agent may determine a price to be offered to the seller for a vehicle.

### CROSS-REFERENCE TO RELATED APPLICATION

This application claims the benefit of U.S. Provisional Patent Application Ser. No. 61/356,273, filed Jun. 18, 2010, U.S. Provisional Patent Application Ser. No. 61,357,718, filed Jun. 23, 2010, and U.S. Provisional Patent Application Ser. No. 61/366,661, filed Jul. 22, 2010, each of which is incorporated herein by reference.

### BACKGROUND OF THE INVENTION

1. Field of the Invention

The present invention relates generally to method and apparatus for estimating the value of a used or damaged vehicle and method and apparatus for buying a used or damaged vehicle. The present method and apparatus also provides a pricing model for pricing used or damaged vehicles.

2. Description of the Related Art

Owners of vehicles such as automobiles and trucks may sell their vehicles through various commercial channels, including as trade-ins with a new car purchase, to a used car dealer or to other individuals such as by using classified advertisements, public notices or through word of mouth. However, the owner of a vehicle that has been severely damaged, for example in an automobile accident, is unlikely to be able to sell the damaged vehicle through the ordinary channels. The owner of either a damaged or used vehicle may be unaware of the price that may be obtained for the vehicle, particularly if the damage is severe. It would be beneficial to provide a tool by which an owner of a used or damaged vehicle can obtain information about the price that may be obtained for the vehicle.

Many vehicles that have been damaged in accidents or by theft or vandalism are obtained from the vehicle owners by insurance companies, for example when the insurance company determines that the cost to repair the damaged vehicle is too high and instead chooses to pay the owner for the vehicle rather than to pay to have it repaired. The insurance companies must dispose of the damaged vehicles. It would be beneficial if a means were provided for insurance companies to easily determine a value of a damaged vehicle and to sell the vehicle for that price.

In addition to vehicles, many other items have a market value after use, even if damaged. For example, office equipment such as copier machines may have a market value as used or damaged equipment. It would be beneficial to be able to determine a market value and to sell used and/or damaged items.

### SUMMARY OF THE INVENTION

The present invention provides, in one embodiment, a method and apparatus by which someone wishing to sell or appraise a used or damaged vehicle may determine a selling price for the used or damaged vehicle. The person wishing to sell the used or damaged vehicle may be the owner of the vehicle, a representative or employee of the owner or other person having possession of the vehicle or a desire to sell the vehicle. According to the present method and apparatus a potential seller of a used or damaged vehicle is shown images of similar vehicles with different levels of damage and the potential seller may indicate the condition of the vehicle to be sold including indicating the extent of any damage to the vehicle by selecting an image of a vehicle having a comparable level of damage as that of the vehicle to be sold. The potential seller is shown a price for the vehicle to be sold which has the comparable level of damage to the vehicle in the image. The potential seller may sell the vehicle for that price.

In one embodiment, the potential seller of the vehicle, here denoted as a user, is shown images of one vehicle at a time and is asked to input whether the user's vehicle has more damage, less damage or about the same level of damage as the displayed vehicle. The images may be photographs, videos, drawings or other image formats depicting the vehicle. The vehicle may be shown in a single image or in several images showing different sides and aspects of the vehicle. If the user chooses more or less damage, the user is shown images of another vehicle with a different level of damage and is again asked if the user's vehicle has more, less or about the same damage. This may continue until the user identifies a vehicle with about the same level of damage as the user's vehicle. The user is shown a price as an offer for the user's vehicle that has about the same level of damage as the displayed vehicle. The user may sell the vehicle to the company for that price.

In another embodiment, the user is shown images of a series of damaged vehicles with different levels of damage. The user selects a vehicle from the displayed selection that has about the same level of damage as the user's vehicle. The user is shown a price as an offer for the user's vehicle that has about the same level of damage as the displayed vehicle. The user may sell the vehicle to the company for that price.

In a further embodiment, a user interface is provided for an employee of a company seeking to purchase used and/or damaged vehicles. The employee user is provided with information on a particular used or damaged vehicle and compares the information on the particular vehicle to information and images displayed on the user interface to determine an approximately matching vehicle displayed to the user. The employee user is provided with price information in order that the user may determine a price to offer for the purchase of the particular vehicle. The information about the particular vehicle may be conveyed to the user employee by telephone by a person seeking to sell the vehicle to the company, or may be conveyed by email, text message, postal mail, or other communication means. It is also possible that the employee user may themselves see the particular vehicle and then access the user interface to determine a price to be offered for the vehicle. The information shown to the employee user may include historical price information on prior purchases and ranking or statistical distribution information indicating a ranking or statistical distribution of vehicle prices obtained for that make and model of vehicle. The employee user may arrange to purchase the vehicle for the price.

The present method is of a scope to encompass a method and apparatus to determine a price of damaged or used motorcycles, motor scooters, ATVs, golf carts, lifting vehicles such as fork lifts, construction equipment such back hoes and trucks, office equipment such copiers and computers, machine tools, presses, medical equipment, and many other devices.

Further details of the present method and apparatus are set forth below, including flowpaths that show what happens as the potential seller looks at a photo of a damaged vehicle and indicates whether the seller's vehicle is the same, better, or worse condition.

### BRIEF DESCRIPTION OF THE DRAWINGS

FIGS. 1-11 are screen shots showing web pages displayed to a user in a first embodiment of the present method according to the principles of the invention;

FIG. 12 is a screen shot showing a web page that displays to a user or prospective seller a purchase price, an auction price and a thumbnail image of a plurality of vehicles that may have been purchased according to the present method;

FIG. 13 is a schematic representation of a computer system utilized in an embodiment of the present method;

FIGS. 14-31 are screen shots of web pages displayed to a user in a second embodiment of the present method;

FIGS. 32-41 are screen shots of web pages displayed to an employee user in a further embodiment of the present method;

FIG. 42 is a screen shot of a web page displayed to a user to describe a vehicle using photos, video, a condition report, an auto check report and an option report;

FIG. 43 is a report as a screen display or print out showing a ranking or statistical distribution of vehicle prices to compensate an employee for purchasing a vehicle at a low price relative to the statistical distribution of vehicle prices;

FIG. 44 is a screen shot of an auction price estimating method according to a further embodiment of the invention;

FIG. 45 is a schematic representation of a screen display showing a tax credit determination screen according to the present invention; and

FIG. 46 is a schematic representation of a web page including vehicle type specific or city specific vehicle purchase information according to a further embodiment of the invention.

### DETAILED DESCRIPTION OF THE PREFERRED EMBODIMENTS

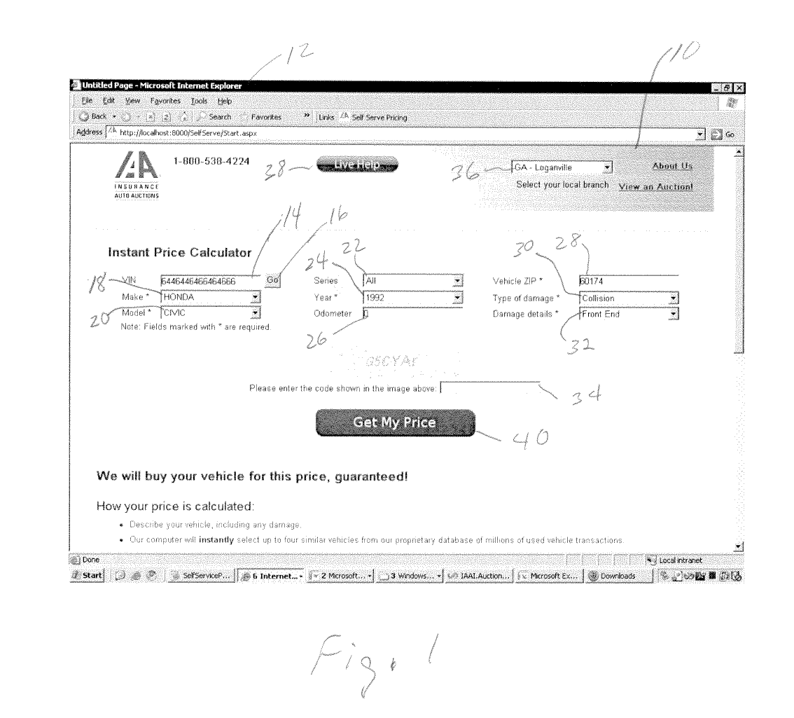

Referring to the drawings, a user that wishes to sell a used or damaged car or truck uses a computer device to access a World Wide Web page 10 as shown in FIG. 1 to begin the process of determining a price for the vehicle. The web page 10 is displayed using a browser program 12 that displays the web page 10 on a display device of a computer apparatus. The web page 10 is written and presented using HTML code, XHTML code, JAVA code, and/or other code and draws information such as images and data from stored information. The computer apparatus may be a desktop or laptop computer, tablet computer, smart phone, music player, computer kiosk, computer gaming system, or other computer device, which is preferably connected to a network, such as the Internet. Alternately, the computer system may be connected to a LAN or WAN or other network, or may be a stand-alone computer. The user may have had to log onto the web site first or otherwise provide user identification prior to reaching the web page of FIG. 1.

At the web page 10 of FIG. 1, the user may enter some or all of the information requested on the page. For example, the user may enter a vehicle identification number or VIN number of the user vehicle at information box 14. The VIN number may be sufficient to identify the vehicle without more information. As such a “GO” button 16 is provided to initiate the search for the vehicle particulars. Instead of or in addition to the VIN number information 14, the user may enter the make 18 and the model 20 of the vehicle. In the example, the vehicle is a Honda Civic.

Additional information may be provided including the series of the vehicle at 22, the model year of the vehicle at 24, the odometer reading of the vehicle at 26, the postal zip code where the vehicle is located at box 28, the type of damage sustained by the vehicle at box 30 and damage details at box 32. The information entry into the blocks may be by the user typing the information into the corresponding space or may entered by selection of an item from a pull down menu. For example, the model year entry may offer a selection of only the model years when the selected model of vehicle were made or only model years for which data is available. The type of damage box may permit the user to select from damage as a result of collision, fire, theft, or flood, for example. The damage entry may offer a selection of only damages for which data is available.

A security question 34 is provided on the page 10 which serves in this case to prevent entry to the page by automated systems. In the illustrated security question, an alphanumeric sequence displayed in a manner not readable by automated systems is displayed and to be typed by a human user into the box 34. Other security measures may be provided as well.

A location identifier 36 may be provided to permit the user to select a branch of the vehicle purchase company nearest to the user. The location identifier 36 serves a further purpose since used vehicle prices vary depending on the location of the vehicle, in particular depending on the area of the country where the vehicle is located. A price variation may be built into the system depending on the area of the vehicle. A help button 38 is provided for displaying help information should the user need it.

Once the information is filled in on the web page 10, the user selects a button 40 which is labeled here as “get my price.”

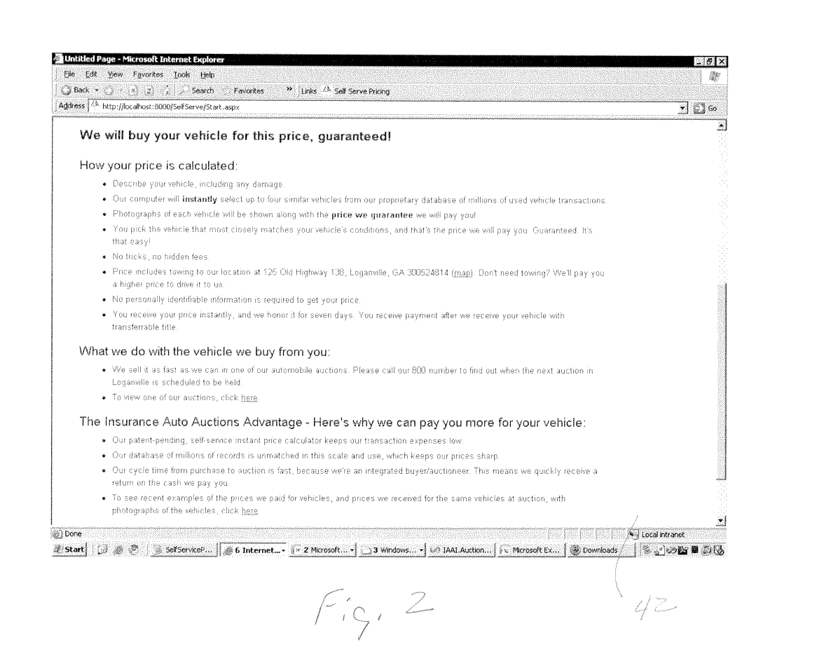

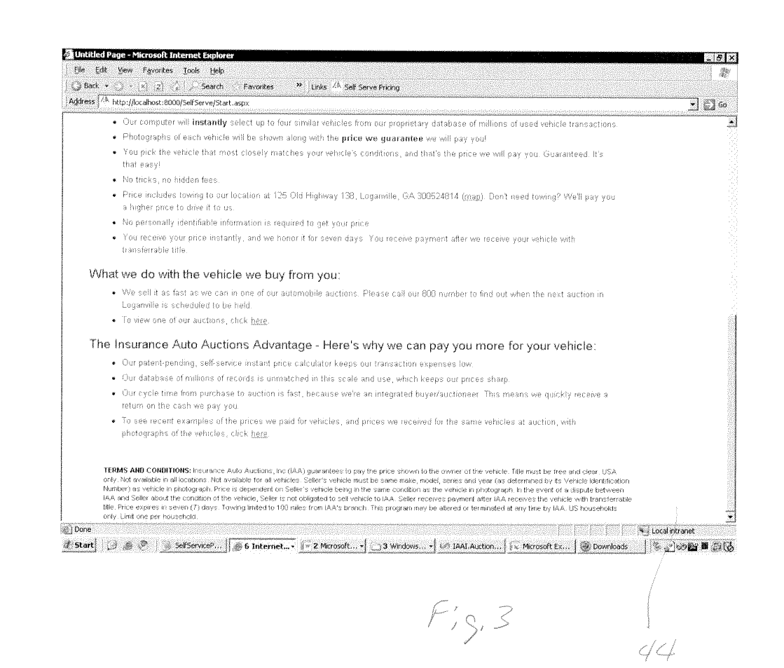

If the user needs more information on the process for determining a price for the vehicle, additional information is provided on page 42 and 44 in FIGS. 2 and 3. The user may view this information by scrolling down in the browser display while at page 10, for example.

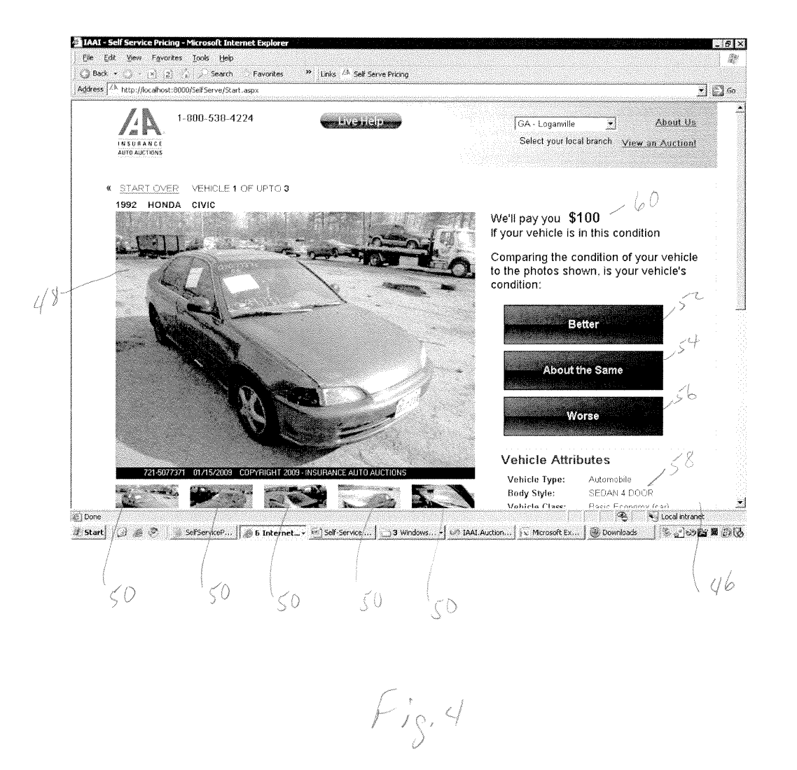

After the user selects the “get my price” button 40, a next page 46 is displayed at shown in FIG. 4. The page 46 shows an image 48 of a vehicle that matches exactly or approximately the make, model and year of the vehicle information input by the user. Preferably, the make, model and year of the displayed vehicle match the input information exactly, although it is possible that the displayed vehicle could be a similar make and model and series or a model year near the input model year. The vehicle displayed in the image is a used vehicle of the type identified by the user that has sustained damage of the type identified by the user, such as a front end collision. The image and associated information about the vehicle is drawn from a database that is accessed by the computer system which the browser has accessed. The database includes images of and information about vehicles of many different makes, models and model years that have sustained different degrees of damage. In the preferred embodiment, the database includes thousands of images of different vehicle models, makes, model years, etc. and for each such vehicle type there are images of many different types of damage and for each damage type there are images of vehicles having different levels of damage.

An algorithm may be used to determine which image or images to display to the user, for example based on the user input. For example, the algorithm may select for display a median price level of damage for that vehicle model and model year, which may be a different level of damage for a different model or model year. Other criteria for selecting the displayed images are within the scope of the invention. The displayed vehicle can be shown in a single image, in a plurality of images, in one or more video clips, by a drawing or by other display format. In a preferred embodiment, a plurality of images of the same vehicle are shown, with one image being displayed larger and the others from other angles, for instance, shown in reduced size but viewable as the larger view by being selected.

The user compares the displayed vehicle in the image 48 to the user's vehicle to determine if the extent of damage is about the same or if the user's vehicle is in better condition (less damage) or worse condition (more damage). To better assist the user in making this determination, a series of images 50 of the displayed vehicle are provided showing the vehicle from different angles, and showing different features of the vehicle. The images 50 are shown as so-called thumbnail images, or reduced size images, that are enlarged for display in the larger display window 48 upon selection by the user.

In addition to showing the vehicle for comparison, the web page 46 includes condition selection buttons that include a button 52 to indicate that the user's vehicle is in better condition (less damage) than the displayed vehicle, a button 54 to indicate that the user's vehicle is in about the same condition (about the same level of damage) as the displayed vehicle, and a button 56 to indicate that the user's vehicle is in worse condition (more damage) than the displayed vehicle. Optional information on the page include a description of the vehicle attributes at 58 so that the user may compare the vehicle attributes of the displayed vehicle with the user's vehicle. An offer price 60 may also be shown on the page 46 if the user's vehicle is in about the same condition as the displayed condition.

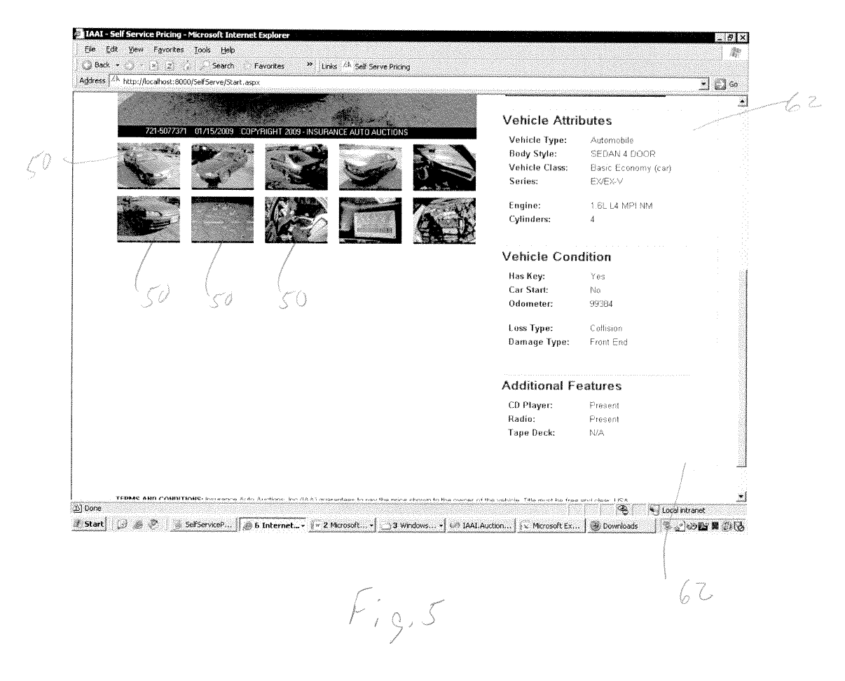

FIG. 5 shows the lower portion 62 of the page 46 where the further images as thumbnail images 50 are shown as are the vehicle attributes 62. The user may scroll to view this information and then return to the portion of the page that includes the vehicle condition buttons 52, 54 and 56.

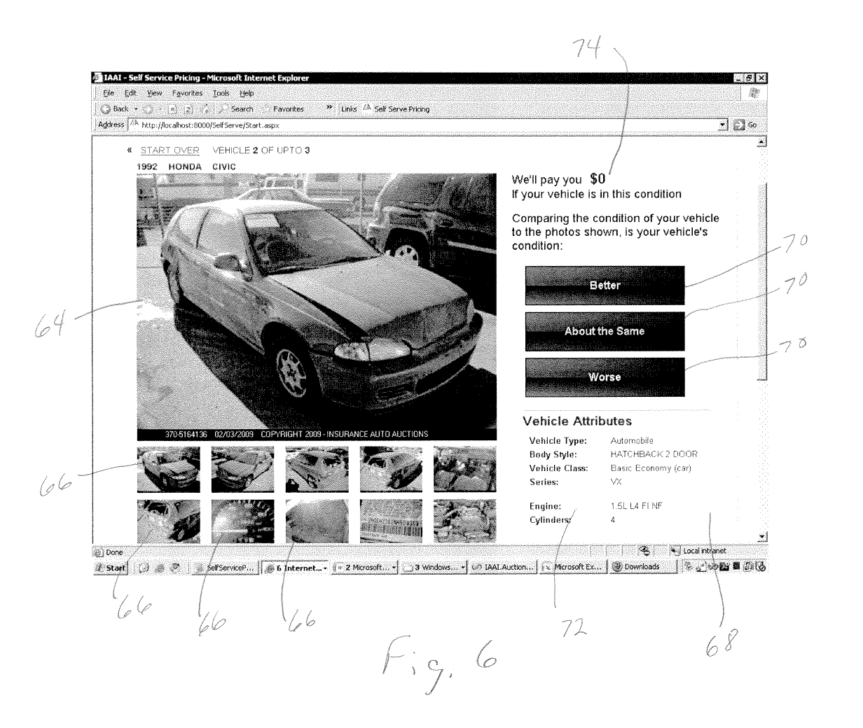

If the user selects the button 54 that the image shows about the same damage as the user's vehicle, the browser is taken to a page to complete the sale. In FIG. 6 is a sample of a page displayed after the user has selected the option that the user's vehicle is in worse condition than the vehicle shown in the image in FIG. 4. In response to this selection, the computer system to which the web browser is connected accesses the database of images of damaged vehicles and obtains images and information on the type of vehicle identified by the user but with a price associated with a greater degree of damage than the vehicle shown in the first image.

In place of an objective determination of vehicle damage, the method of some embodiments uses the auction price as a measure of damage. It is also possible that an objective determination of damage may be used or that other measures of damage or price could be used in other embodiments. To identify a vehicle with a greater degree of damage, the system looks for a vehicle that has a lower auction price (after normalizing for matters such as title, type, time and geography and displays that vehicle to the user. Conversely, to identify a vehicle with a lesser degree of damage, the system looks for a vehicle with a higher auction price. The displayed price may be rounded to a nearest value, such as to the nearest $25 value.

In some embodiments, an algorithm in the present system determines the price interval between the last displayed vehicle and the next displayed vehicle. The price interval between displayed vehicles should not be too large, but it is of little use too if the interval is too small. For example, if the first displayed vehicle is priced at $5,000, the next lower displayed price should not be $1,000 nor should it be $4995 if there is data for vehicles having prices associated with damage that are less than $4995 and greater than $1000. The interval is selected to be at least a minimum price between displayed vehicles. Various techniques for determining the next displayed price, such as tables of price intervals and variable intervals that depend on data density, are encompassed within the present method and will be discussed in greater detail hereinafter.

The purchase price to be displayed to the user is determined by starting with the auction price paid for a similar vehicle in the database. If the auction occurred in the sufficiently distant past, an adjustment of the auction price of the vehicle in the database to an equivalent current price may be made. Adjustments are then made to the display price depending on information input by the user relating to the user's vehicle. For example, if the user's vehicle has higher mileage on the odometer or lower mileage on the odometer than an average value for vehicle of that age or model year, the price is adjusted downward or upward. The location of the user's vehicle is factored into the price determination. For example, the cost to transfer the title of a vehicle varies from state to state. The cost of the title transfer for the state where the vehicle is located is added to the price, using the postal code or zip code information that is associated with the vehicle to identify the vehicle location. The location information, as reflected by the postal zip code, is used to determine the expected cost for towing the vehicle to a local office of the purchasing company. For example, towing prices may be lower in area with greater competition for towing services and higher in areas with less competition. The expected towing costs are added to the price. Other known overhead items may be included in the price as well.

In an embodiment of the method, different regions of the country are assigned regional price adjustment factors that reflect, for example, regional differences in auction prices. By applying the regional price adjustment factors, it may be possible to use a price from one region for a price determination in another region of the country. In one embodiment, a plurality of price adjustment factors are provided and each region of the country is assigned one of the adjustment factors so that prices can be used from region to region as needed.

After the auction price is adjusted for mileage, time, title transfer costs and towing costs, a predetermined margin cost is added to the price and it is this total that is shown to the user as a purchase price. In one embodiment, the calculation of price including factoring in auction price, towing costs, titling costs, mileage, and time is performed using the computer system to perform the calculation on a plurality of vehicles in the database. The price determination may be run for some or all of the vehicles in the database that match the make, model and year of the user's vehicle, or may even be run for additional vehicles in the database as well. From the results of these calculations, the vehicles for display are chosen. Additional factors that may be used in the price calculation of future embodiments might include initial value of the vehicle, collector value of the vehicle, rarity, etc.

In FIG. 6, an image 64 of a vehicle that matches the make, model and model year input by the user and that has the type of damage indicated by the user and which also has a greater degree of damage than the vehicle shown in the image first shown to the user. Further images of the second damaged vehicle shown as reduced size thumbnail images 66 which can be enlarged by selection are also included on the page 68. The page 68 includes buttons or other selection indicators 70 that the user may select to indicate whether the user's vehicle is in better condition than the illustrated vehicle, in about the same condition, or in worse condition. A vehicle description section 72 and a price indication 74 is included.

The user may determine that this image set shows a vehicle with about the same level of damage. Alternately, the user may continue to go through one or several more levels of comparing images of damaged vehicles to the user's vehicle until a near match is found. Or the user may determine that the first or second presented images show a vehicle with a level of damage that is a match or near match to the damage to the user's vehicle. Where a match is made on a page that indicates a price for the vehicle, the user may sell the user's vehicle to the company for the indicated price.

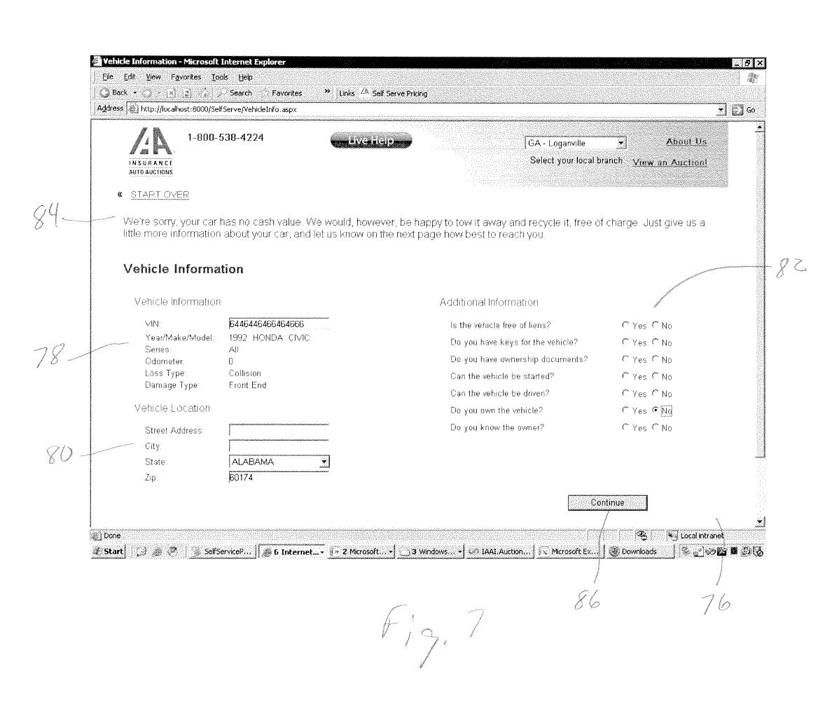

In the illustrated example, the user has selected the button in FIG. 6 indicating that the vehicle shown in the image shows a vehicle that has about the same degree of damage as the user's vehicle. This brings up the page 76 shown in FIG. 7 for display in the browser program. The user is presented with boxes 78 in which to input the vehicle information, boxes 80 to input the address where the vehicle is located, and a series of so-called radio buttons 82 for entering additional information that includes, for example, an indication of whether the vehicle is free of liens, whether the user has keys for the vehicle, whether the user has the ownership documents, whether the vehicle can be started, whether the vehicle can be driven, whether the user is the owner of the vehicle or whether the user knows the owner. To the extent that the user has already input vehicle identification information in previous screens, the program may include the already entered information in this screen so that the user need not enter it twice.

In the illustrated example, the degree of damage identified by the user for the user's vehicle in conjunction with other factors such as whether the vehicle has higher mileage on the odometer or lower mileage on the odometer than an average value for vehicle of that age or model year, etc. result in the offered price for the vehicle being zero. Instead of a cash offer, the page 76 includes a statement at 84 that the company will tow the vehicle away and recycle it at no charge but that transfer of the vehicle will not result in a payment. If the user accepts this offer, the user selects the continue button 86.

After selection of the continue button 86, the browser page display 88 opens as shown in FIG. 8. The page 88 indicates that the company will contact the user regarding acquiring the vehicle at 90. A confirmation number 92 is provided for the transaction. A terms and condition statement 94 guarantees the terms offered at the website.

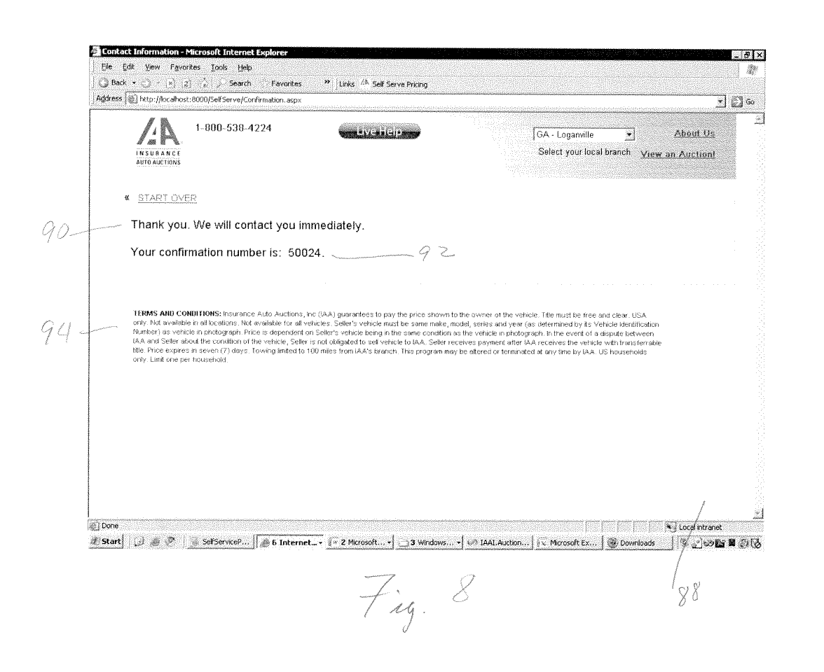

In FIG. 9, a page 96 is displayed in the web browser program after the user has determined that the user's vehicle is in better condition than the vehicle shown in the image on page 46 as shown in FIG. 4. In other words, the degree of damage is less than shown in the images. The page 96 includes an offer price 98 to pay $500 for the user's vehicle. Displayed with the offer price 98 are boxes 100 for entry of information about the vehicle, which as noted above may already be filled in to the extent the user has previously entered this information, boxes 102 for indicating the vehicle address, and inputs 104 for indicating the additional information about the vehicle as mentioned above. After completion of the information, the user selects a continue button 106, which takes the browser to the next page.

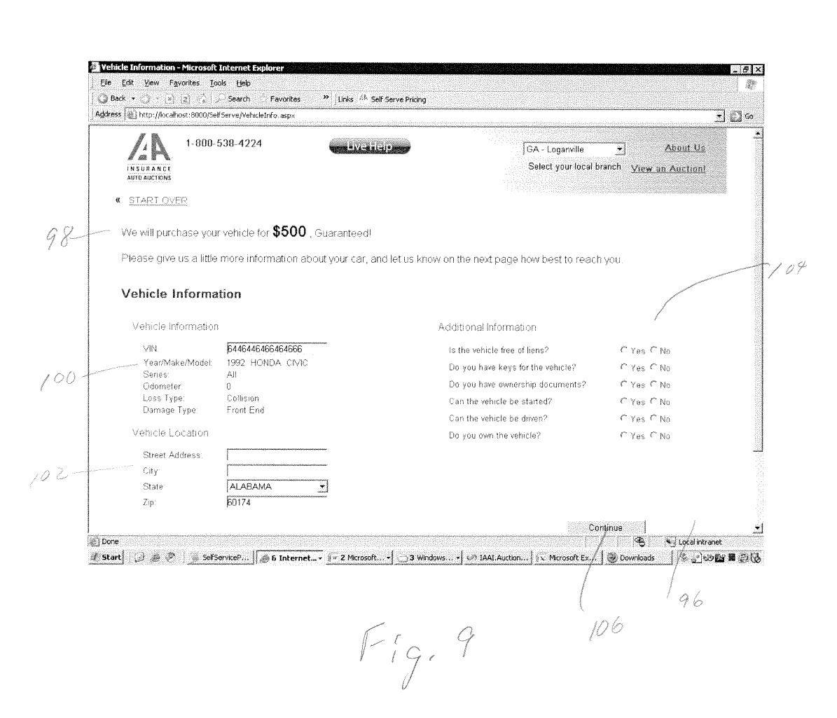

FIG. 10 shows an example of a page 108 that is reached after the user has input the information into the page 96 in FIG. 9 to accept the offer price 98 for the user's vehicle. The page 108 asks for input of contact information for the user at input boxes 110. Delivery options 112 are selected by the user to arrange for delivery of the vehicle to the company or for pick up of the vehicle by the company from the address provided. The terms and conditions 114 for the vehicle offer are set forth. Once the user is satisfied with the offer and has completed the user information input, the user selects the “submit” command 116.

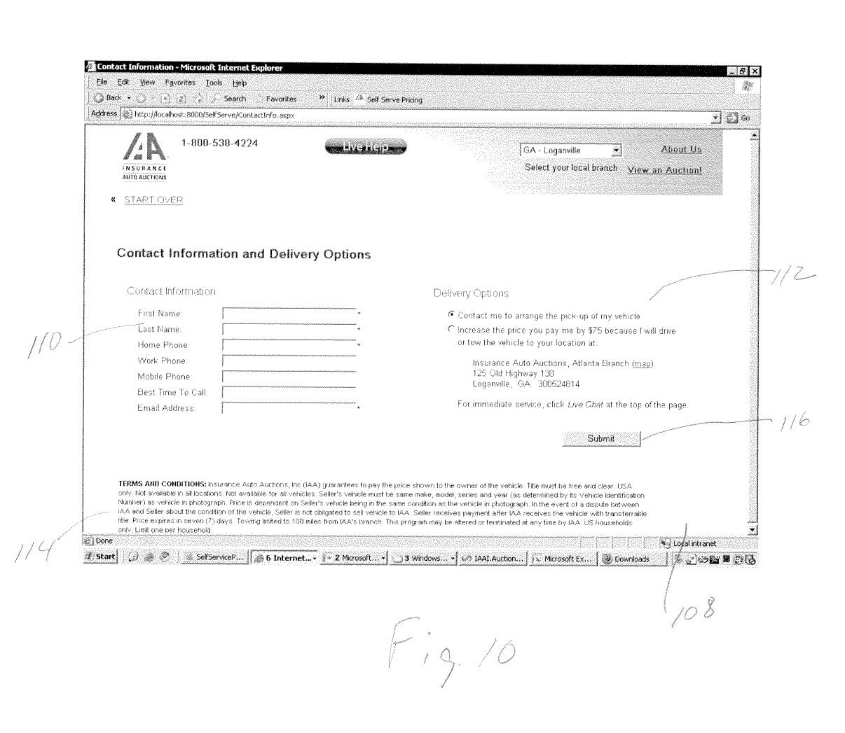

On page 118 shown in FIG. 11 the user is informed, at 120, that the company will contact the user at the requested time and, at 122, of the confirmation number for the transaction. The terms and conditions 124 are again set forth for the user.

When the purchase of the vehicle is completed, the system provides the information on the vehicle and the purchase price to the server for entry into the database stored on the server. The database is thereby continually updated with current information. As new information comes in which covers the same vehicles and same level of damage as information already in the system, the algorithms of the system may remove older information or express a preference for newer information.

The user who accesses the web site and follows the process steps to sell a vehicle may be the owner of a vehicle that was damaged in a wreck, fire, flood or by theft or vandalism or has normal wear and tear. The user may be an employee or representative of a company who owns the vehicle, for example where the vehicle is a fleet vehicle of the company. The user may instead be an employee of an entity, such as an insurance company, who has acquired the title to the vehicle from the owner following a wreck or other damage to the vehicle. As such, references herein to the user's vehicle refer only to the vehicle about which the user is accessing the website and do not denote ownership, possession, an ability to sell the vehicle, or other relationship between the user and the vehicle.

It is envisioned that insurance companies who have acquired vehicles as a result of claims made upon insurance policies covering the vehicles and who need to dispose of the damaged vehicles will find an easy, reliable and predictable way to rid themselves of the vehicles and that salvage operations who wish to acquire vehicles for parts, for rebuilding, for scrap, or other salvage purposes may find the present website a convenient source for their needs.

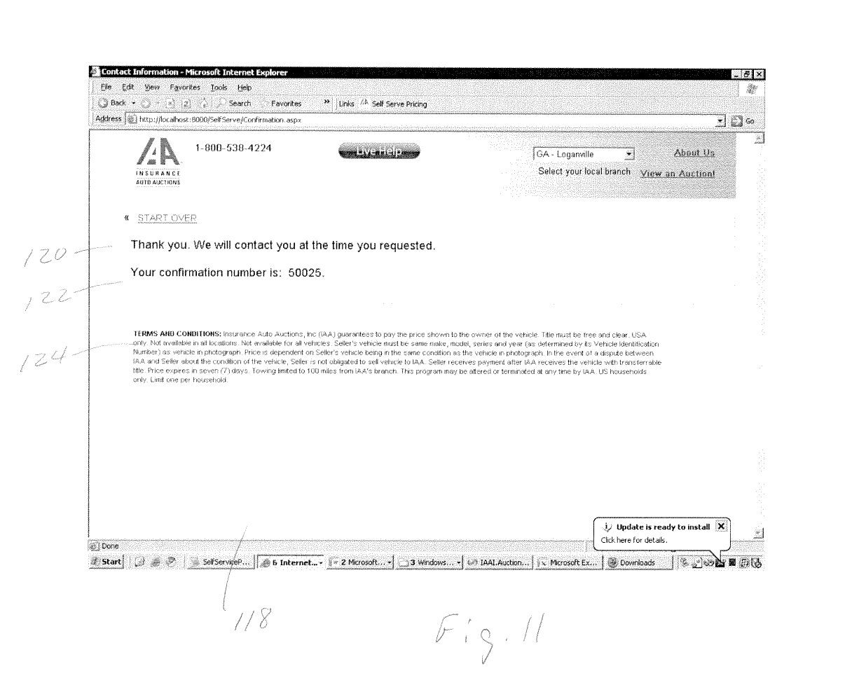

In FIG. 12 is shown a page 130 on which is displayed used and/or damaged vehicles in thumbnail images 132 for vehicles that have recently been purchased by the company. For each image 132, a description 134 of the vehicle is provided along with a purchase price 136 that indicates the price paid for the vehicle to the owner and an auction or selling price 138 that indicates the price obtained by the company when the vehicle was sold at an auction. The page 130 can be viewed by prospective sellers to determine the profit margin implied in the price offered by the system. In other words, the user may not have a clear understanding of the prices typically obtained for damaged vehicles at auction and the reporting of actual purchase and auction prices along with information on the vehicles sold at auction provides the user with the information necessary for the user to understand what auction price might be expected for the user's vehicle.

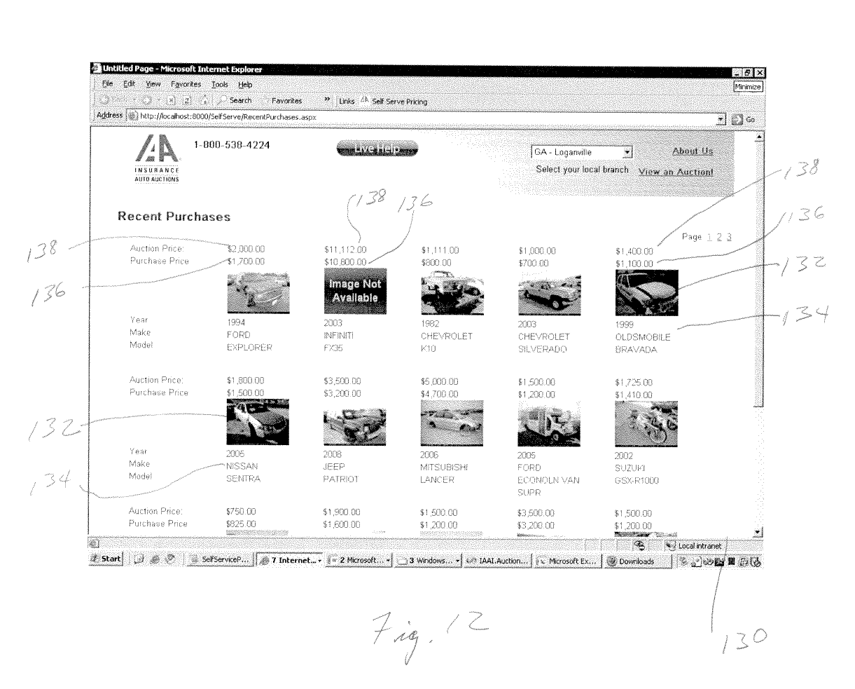

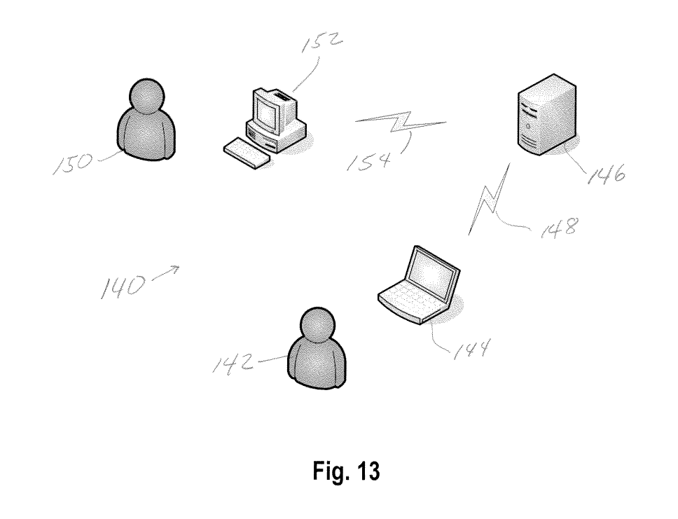

FIG. 13 shows an example of a computer system 140 for performing the present method. Other computer systems are of course possible. In the computer system 140, a user 142 uses a computer device 144 to access a server 146 on which is stored the information on the vehicles that have been purchased by the company. Of course, multiple servers may be provided and back-up and external storage media may be provided as well. The user's computer device 144 accesses the server 146 via a communication link 148, which can be a network connection, the Internet, a wired or wireless connection, or any of a variety of communication means. Data is transmitted between the computers via the communication links according to the steps of the present method. Details of the data transmission will be apparent to those of skill in this art from a review of the present specification and claims. The user's computer 144 runs a browser program that is stored on the computer readable memory in the computer 144 and is executed on the processor of the computer 144 so that the contents of the web page data from the server 146 are displayed on the display screen of the computer 144. The server 146 stores the web page data, the vehicle data, and algorithms for performing the present method on computer readable media in the server or accessible by the server. In particular, the server stores and executes algorithms that determine the interval between prices shown to the prospective seller. The intervals may be a fixed interval for a given situation or vehicle or variable intervals may be used. If the database lacks information on vehicles at the desired intervals, the server may also include an algorithm for filling prices in gaps between prices in the database. The server may include an algorithm for selecting which vehicle to display for the price shown to the seller.

FIG. 13 also shows an agent 150 using a computer 152 to access the server 146 via a communication link 154. The agent 150 may upload data to the server 146, such as information and images of vehicles that can be displayed to the user 142. In an alternate embodiment to be discussed hereafter, the agent 150 accesses the server 146 to view the vehicle data stored there. The agent 150 is able determine a price to be offered to a vehicle owner for a damaged vehicle by viewing the various images and information on comparable vehicles. The agent 150 can communicate with the vehicle owner in person, via telephone, via email, text, or other communication means to assist the vehicle owner in obtaining a sale price for the vehicle.

For the agent embodiment to be discussed in further detail hereinbelow, the server may also include an algorithm for determining a price percentile for the price shown or disclosed to the buyer for example at the top of the screen. An algorithm may also be provided to determine the price percentile for each price shown or disclosed to the buyer. For the management interface, an algorithm is provided for using the price percentile to compensate the buyer for negotiating a low risk price.

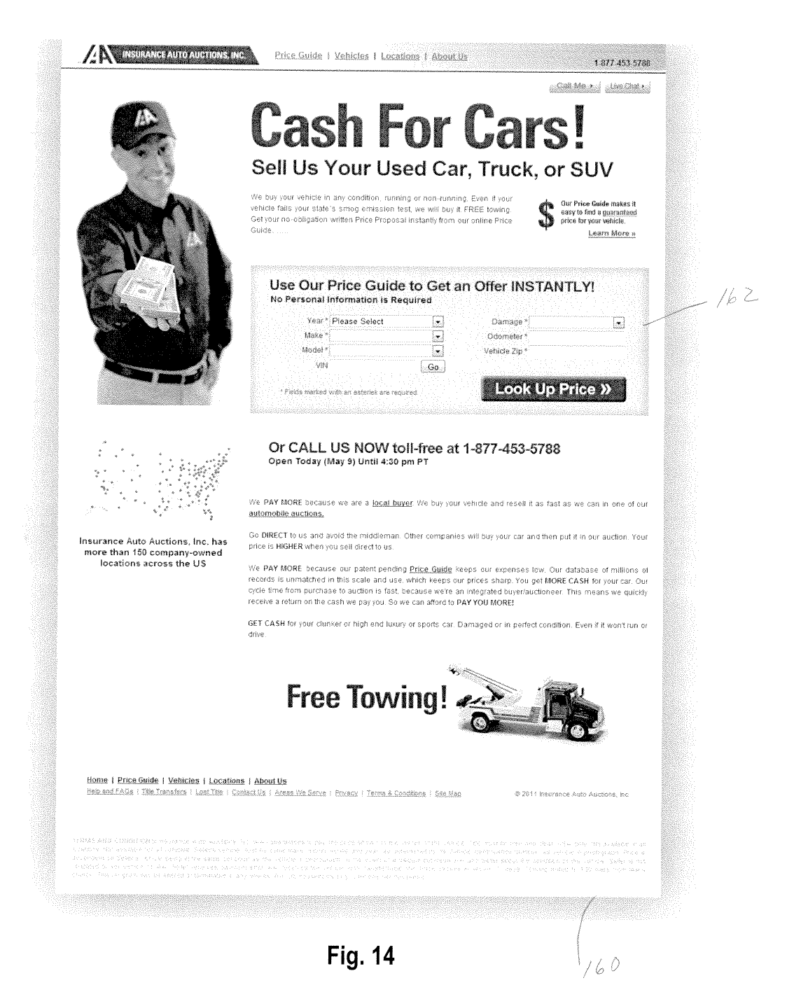

Turning to FIG. 14, another embodiment of the web site for users to sell used or damaged vehicles is shown. FIG. 14 shows the home page 160 of an embodiment of the web site for seller access, via which further pages are accessed. The page 160 includes input blocks 162 for vehicle information to be filled in by a user who wishes to sell a vehicle. Additional information is presented on the web page, the meaning and function of which is readily apparent to persons of skill in the art from a review of prior descriptions herein and will not be describe again for the sake of brevity. The preferred embodiment of the method provides a web site that is user friendly and that explains each step to the user as will be apparent by examining the drawings. Other pages shown and described herein

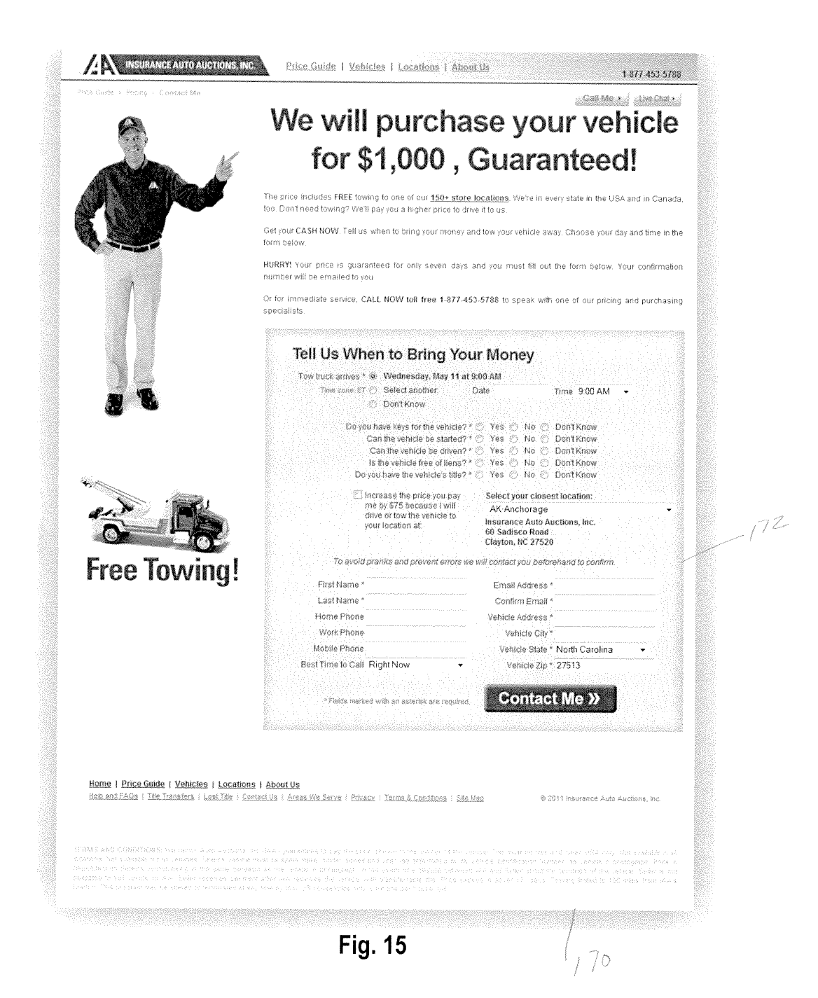

The web site includes a contact information page 170 as shown in FIG. 15 including blocks 172 for inputting user information so that the company can contact the user. The user information blocks 172 also includes information about the vehicle such as whether it can be started and driven.

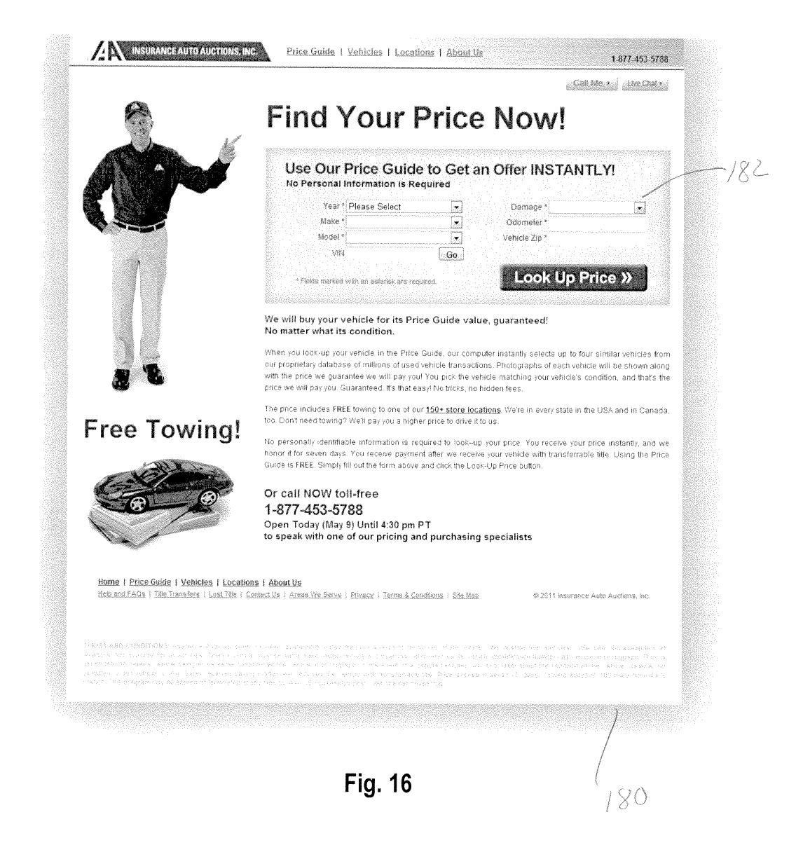

FIG. 16 shows the price guide page 180 via which the user inputs vehicle information at the blocks 182 for input the system so that the system can look up prices for the vehicle. If this information was previously input, the information may already appear on this page.

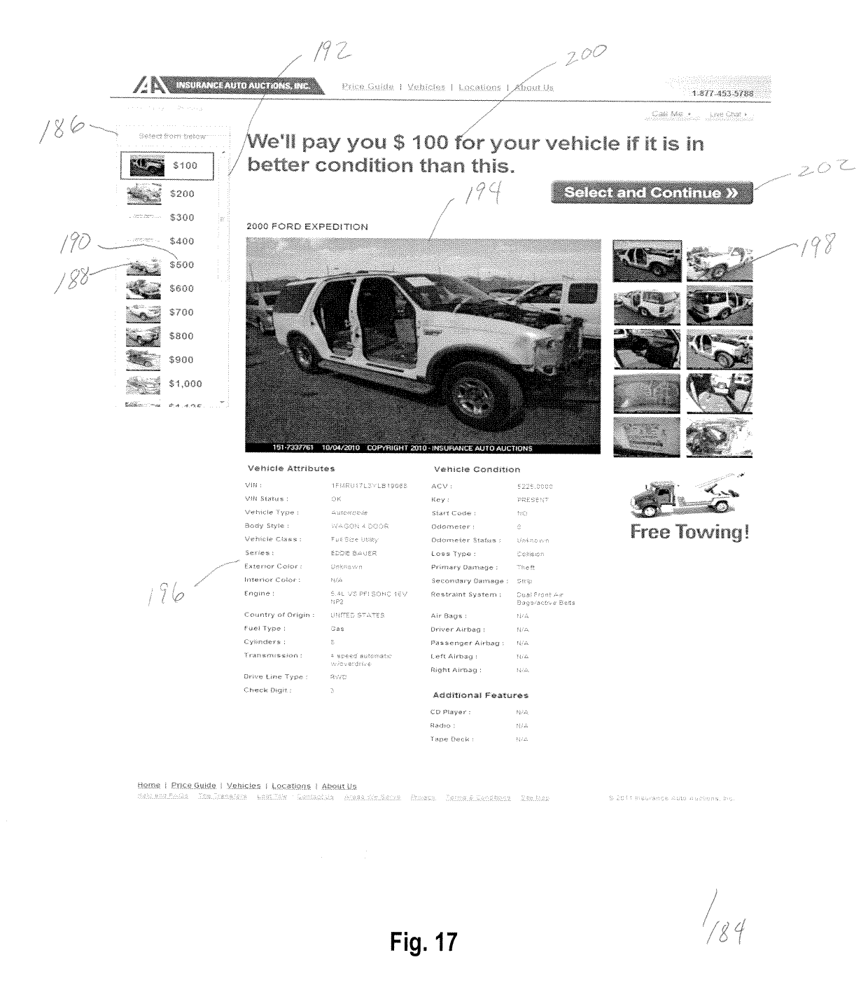

FIG. 17 shows a pricing page 184 that displays a plurality of damaged vehicle images 186 that span a range of levels of damage and a range of prices. A thumbnail image 188 and a price 190 is provided for each vehicle. The prices 190 span the range of possible purchase prices for the vehicle model and age that is available in the database, and where necessary the full extent of the price span is visible to the user by a sliding bar 192 that is moved to show prices and vehicles that are scrolled out of view. The price span presents the prices 190 at price intervals that are determined by an algorithm running on the computer system, such as on the server. Two interval systems are described, a fixed interval system and a variable interval system. In a fixed interval system, the price interval is specified for a given price range. The price interval may be different but nonetheless specified for other price ranges. The price interval of the illustrated page is $100 for the prices shown, so that a damaged vehicle image is presented for each $100 interval along the price span. At higher prices in the price span, as might be visible by scrolling the view, the price interval is greater than $100. For example, at higher prices the interval between adjacent prices may increase to $200, while at still higher prices the interval may be $500. The price interval algorithm may generate the intervals by a formula or by access to a look-up table of price intervals for different price ranges. In the preferred embodiment, a look-up table is provided that include price bins that each define a range of prices. Prices are displayed that fall into adjacent price bins. The system avoids displaying prices that fall within the same price bin, so that only one price per price bin is shown.

Instead of this fixed price interval presentation which does not vary based on the statistical distribution of data available for the specific vehicle, an alternative price interval may be used. For example, a price interval may be used that varies based on the statistical distribution of data that is available in the database for the specific vehicle. Different intervals are provided if the highest price for the specific vehicle is $10,000 than if the highest price is $100,000. If the number of vehicles available in the database associated with a particular price is higher, the price interval near that price for displayed vehicles is smaller than if fewer vehicles are associated with that price. For example, if a specific vehicle type has many vehicles in the database near the $5,000 price, the variable price interval system displays smaller intervals between adjacent prices for prices near $5,000 than the intervals displayed for other prices along the total price span for that vehicle. Algorithms running on the server perform the calculations necessary to provide such price interval displays. Other price interval arrangements may also be used and are encompassed within the present method.

Where no data is available in the database for a price interval, the method and system may perform a gap filling function. A vehicle is moved from a price interval for which the data of several vehicles is available to an adjacent price interval for which no data is available (an empty interval). A price for the empty interval is applied to the moved vehicle, thereby filling the empty interval. The system of a preferred embodiment may move vehicles for up to two intervals to fill gaps. Larger gaps are not filled in the preferred embodiment. A preference for moving vehicles up the price scale or down the price scale may be imposed on the system. Thus, gaps in the price intervals for which no data is available are filled.

When the user selects a thumbnail view 188 and a price 190 from the price span, the selected vehicle is shown in a larger view window 194. Information about the displayed vehicle is shown at 196 and additional images of the vehicle are presented as thumbnail images 198. By selecting one of the additional images 198, the image shown in the thumbnail size image is displayed in the larger view window 194. The user can thereby examine various aspects of the displayed vehicle for comparison to the user's vehicle. The images and the accompanying data are stored on the server and transferred to the user's computer for display by the computer system. As a result, the user is able to select an image of a vehicle that most closely matches the condition of the user's vehicle and can determine the price that the company is willing to pay for the user's vehicle from the price information 200 on the screen. Once the user finds the matching level of damage, the user selects the button 202 marked “select and continue.”

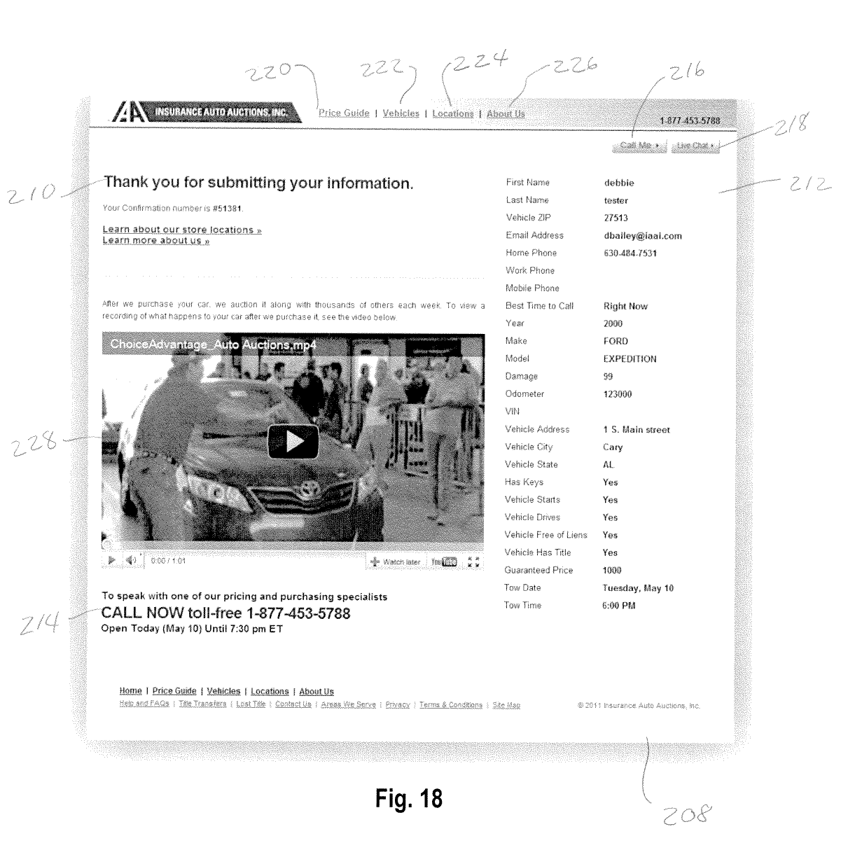

After the user selects the continue button 202 on screen 184, the method proceeds to the display screen 208 as shown in FIG. 18. The screen 208 thanks the user for using the system at 210 and includes confirmation information at 212 that verifies the information entered by the user in the prior screens. The confirmation information 212 also confirms the price to be paid for the vehicle and the time and place where the vehicle will be picked up. The thank you page 208 also includes contact information 214 so that the user may contact the company, a call me button 216 requesting the company to contact the user by telephone, and a chat button 218 that opens a live chat window so that the user may chat with the company representative.

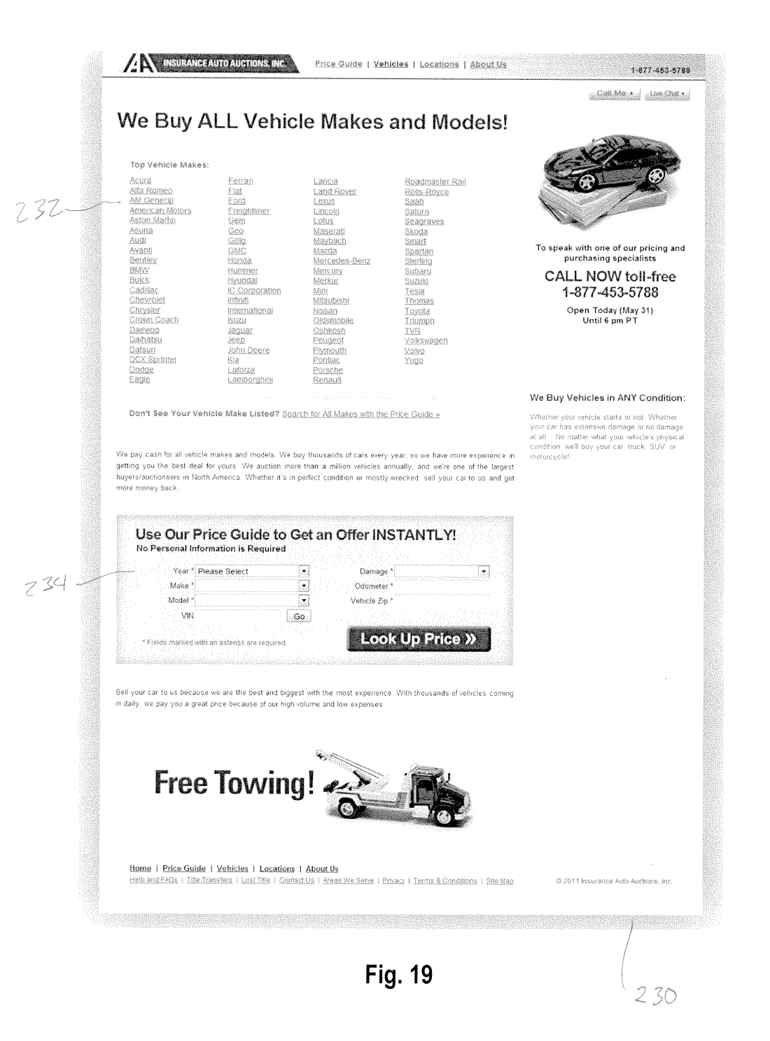

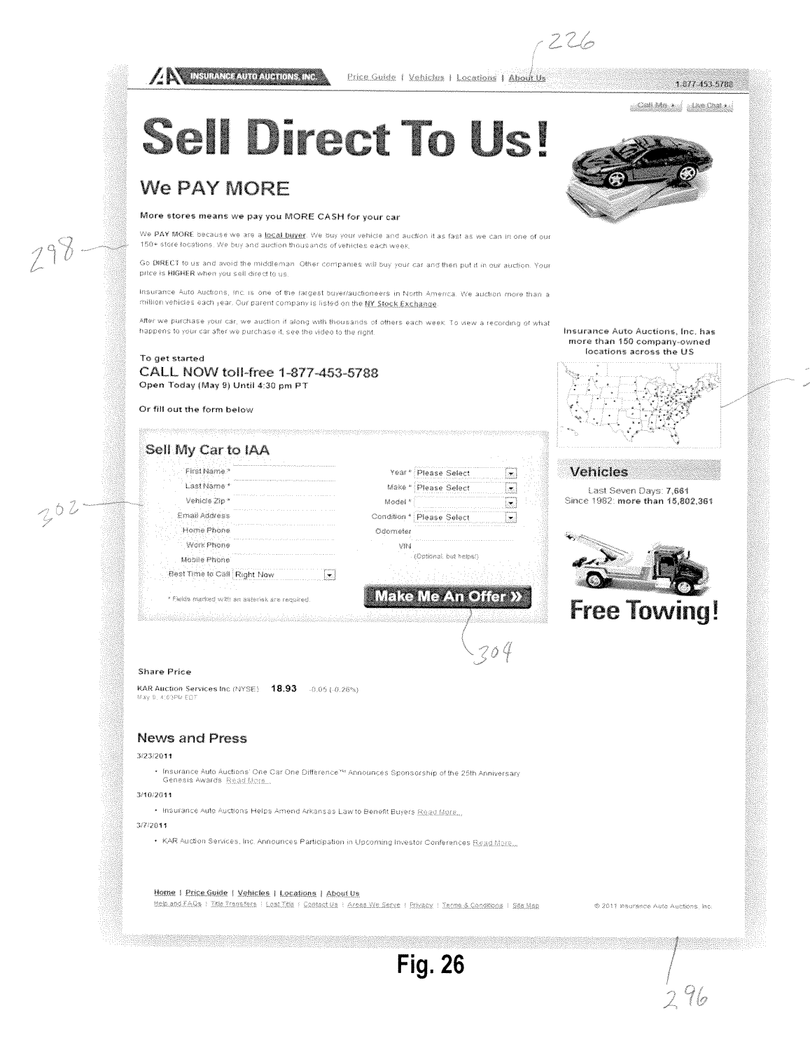

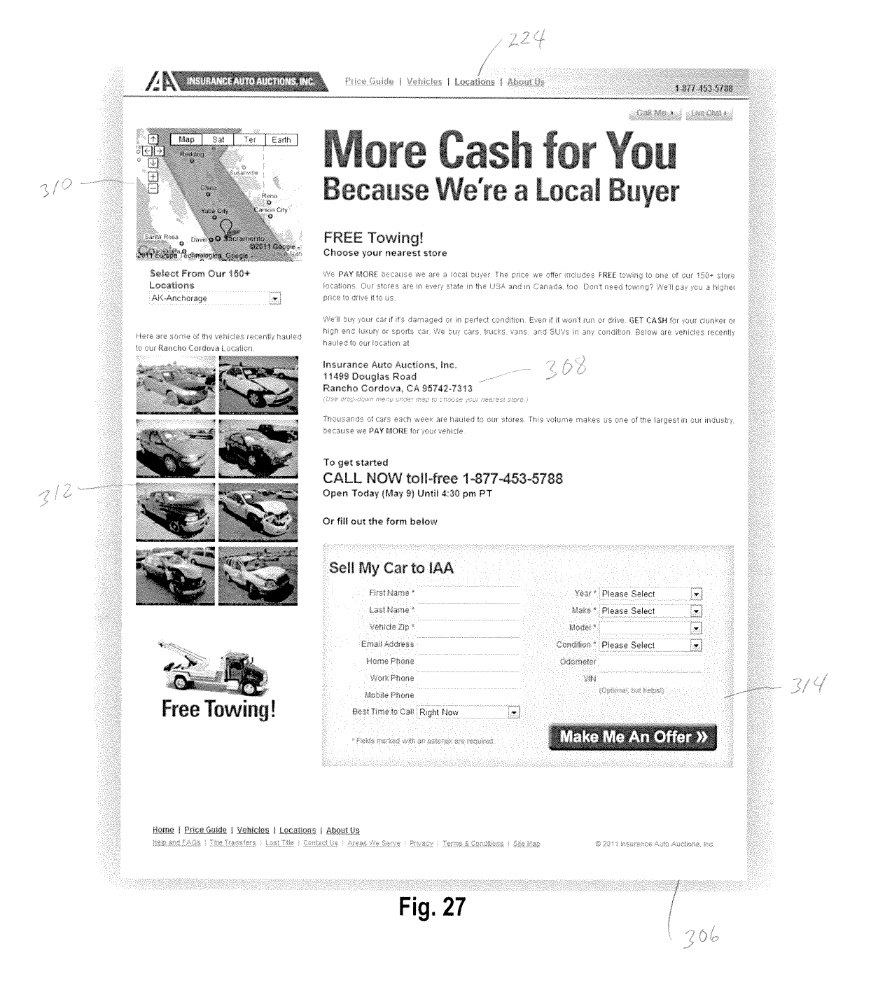

At the top of the page 208 and on other pages is a series of links that open other pages in the browser program. For example, the price guide link 220 takes the user to the page 180 shown in FIG. 16, the vehicles link 222 takes the user to a page such as shown at FIG. 19, the locations link 224 takes the user via the browser to a page such as shown in FIG. 27 identifying locations of the company to which the vehicle may be driven or to which it will be towed, and the about us link 226 takes the browser to FIG. 26 and provides information on the company. A video link 228 is provided to show the user an auction of a used vehicle to let the user know what will happen to their vehicle after the sale.

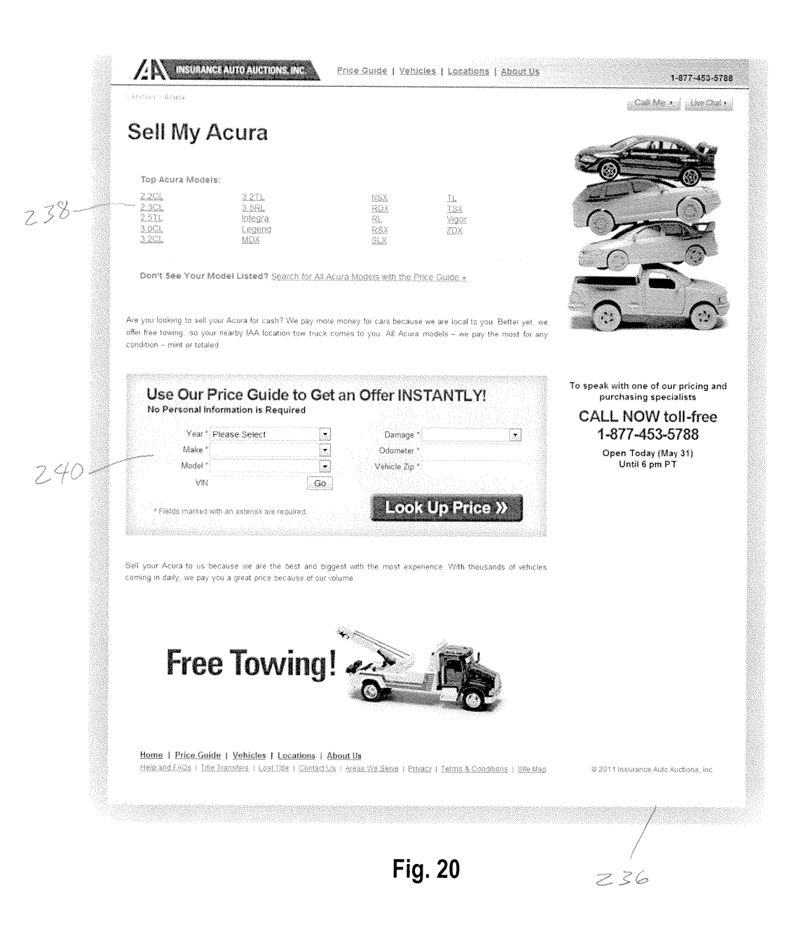

Turning to FIG. 19, a vehicle page 230 is shown on which is displayed a list 232 of vehicle makes or manufacturers that can be sold via the method. The page 230 is reached by selection of the vehicles link 222 that appear on the pages. On the vehicle page 230, the user may select one of the listed makes of vehicle, which takes the user to a listing of models by that manufacturer as shown in FIG. 20. A set of data input blocks 234 is provided into which the user may input information on the user's vehicle to obtain a price at the price guide page 184 in FIG. 17.

In FIG. 20, the user has selected a make of automobile on page 230, which in the example is an Acura, and has been taken to page 236. The page 236 includes a listing 238 that shows the models of vehicles made by the selected manufacturer. Each model is an active link that takes the browser window to price and condition information for that particular model of vehicle. The page 236 also includes a series of input blocks 240 into which the user may input specific information about the user's vehicle and which takes the browser to the price guide page of FIG. 17.

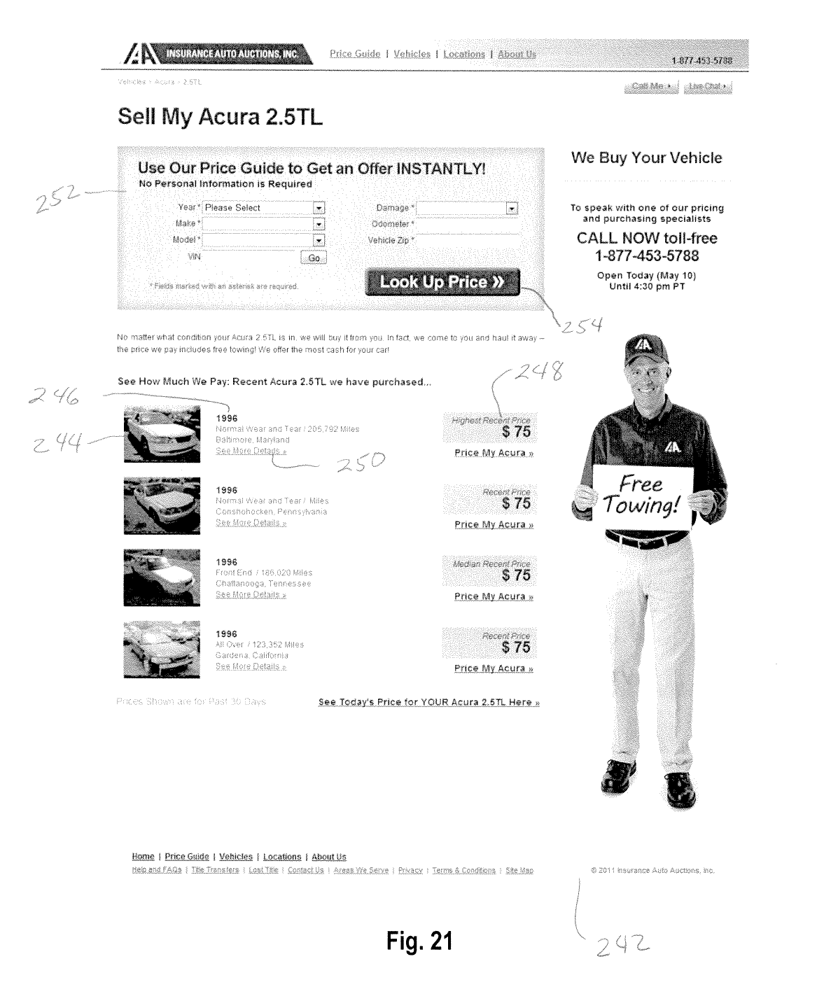

In FIG. 21, the user has selected an Acura 2.5TL model car from the page 236 and is taken to the page 242 where a plurality of vehicles matching the selection are shown. The vehicles are shown in a thumbnail image 244, a description of the vehicle is provided at 246 and a price 248 is displayed that was paid for the illustrated vehicle. A link 250 is provided that permits the user to get more details about that type of vehicle, such as by providing a vehicle information input block that is already filled out with the information on the vehicle selected by the user from the vehicle description 246. For example, the make, model and year of the vehicle are already filled in by the user selecting one of the displayed vehicles.

The user may instead choose to input their vehicle information into a vehicle information input block 252 on the page 242. Activation of the look up price block 254 takes the browser to the price guide page of FIG. 17, for example.

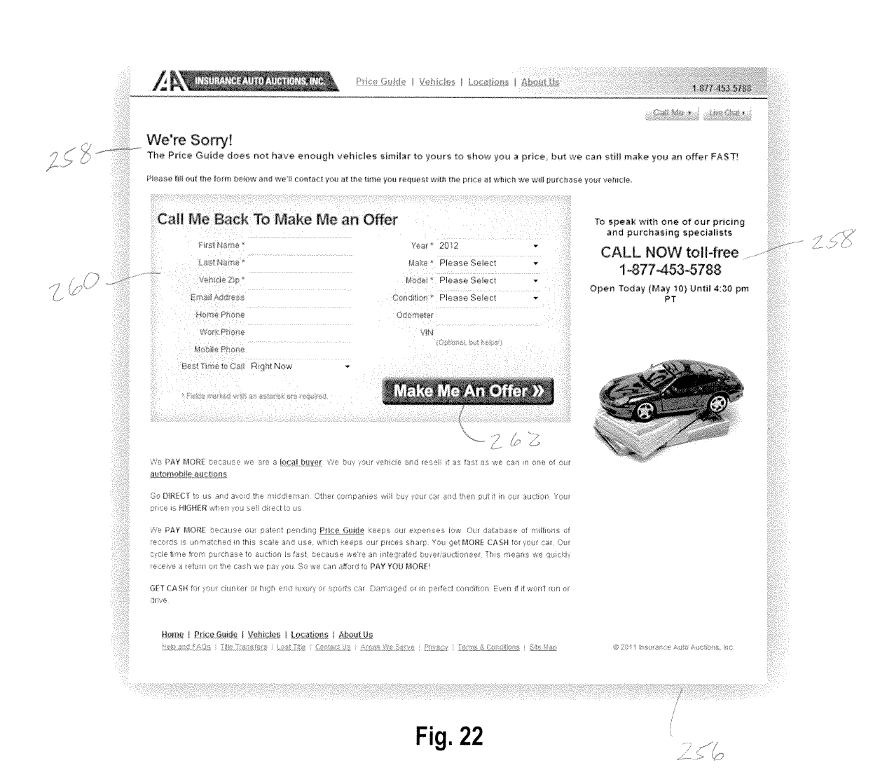

If the user selection on page 230 (FIG. 19) or page 236 (FIG. 20) is for a vehicle about which the database on the server has insufficient similar vehicles, a page 256 as shown in FIG. 22 is displayed. The page 256 may also be reached from other pages where the user has entered a request for a price on a vehicle about which the database does not have sufficient information. The page 256 indicates at 258 that the automated pricing system does not have information on enough vehicles to obtain a price for the designated vehicle. The user may still sell the vehicle to the company, however, by filling in the user information and vehicle information at the series of input blocks 260 and selecting the button 262 requesting that the company contact the user. The user may also contact the company directly at the posted telephone number 258. When the company representative and the user communicate, the user may use an embodiment of the present method and apparatus to be described hereinafter to determine a price for the user's vehicle.

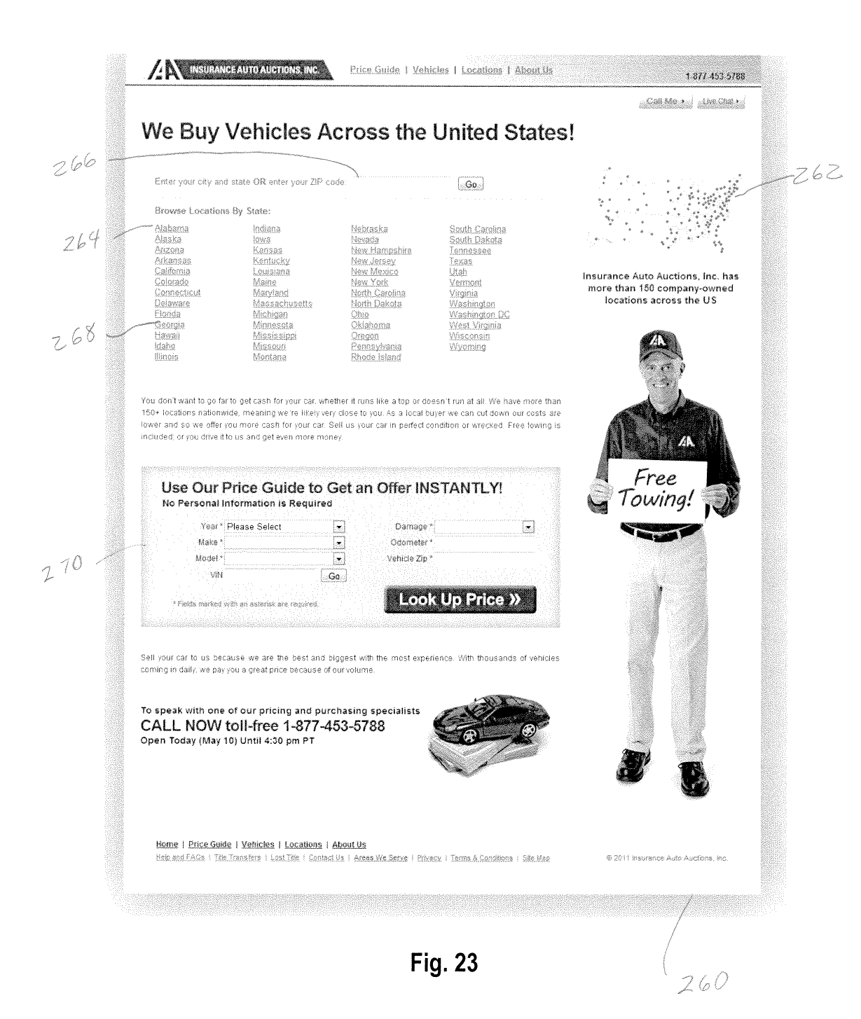

Other user pages are also provided, including a page 260 shown in FIG. 23. This may be reached by checking the “areas we serve” link at the bottom of the page. The page 260 indicates the areas served by the company. The service areas are based on contiguous sets of postal codes proximate to an incorporated area. In another example, the service area is all areas within 250 miles of the company locations. The page 260 also includes a location finding block 264 that permits the user to input the user or vehicle location by entering a zip code at 266 or by selecting a state from the listing 268 of states. Each state is an active link, as are many other text listings of the present web pages. Similar to other pages, a block 270 for vehicle information entry is provided.

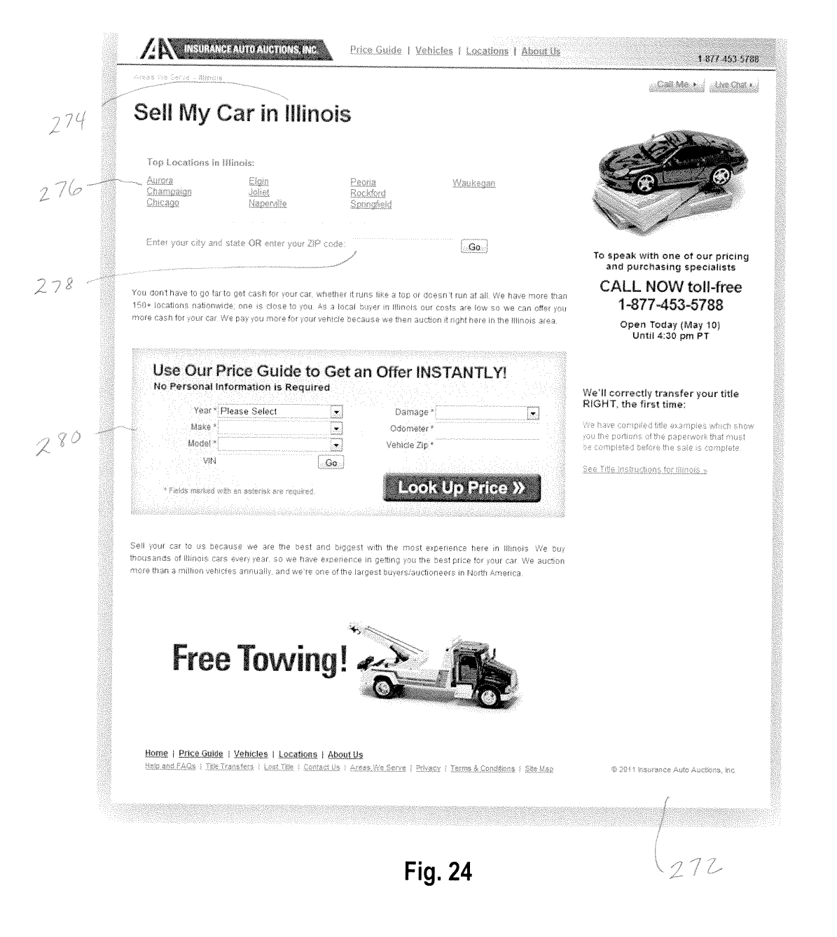

If the user selects a state in the state listing 268 on page 260 in FIG. 24, the browser is taken to page 272 that identifies the selected state 274 and that includes a listing 276 of cities in the state served by the company. The user may enter a city or postal code at block 278 to have the system select a city of interest. The vehicle information block 280 is also provided.

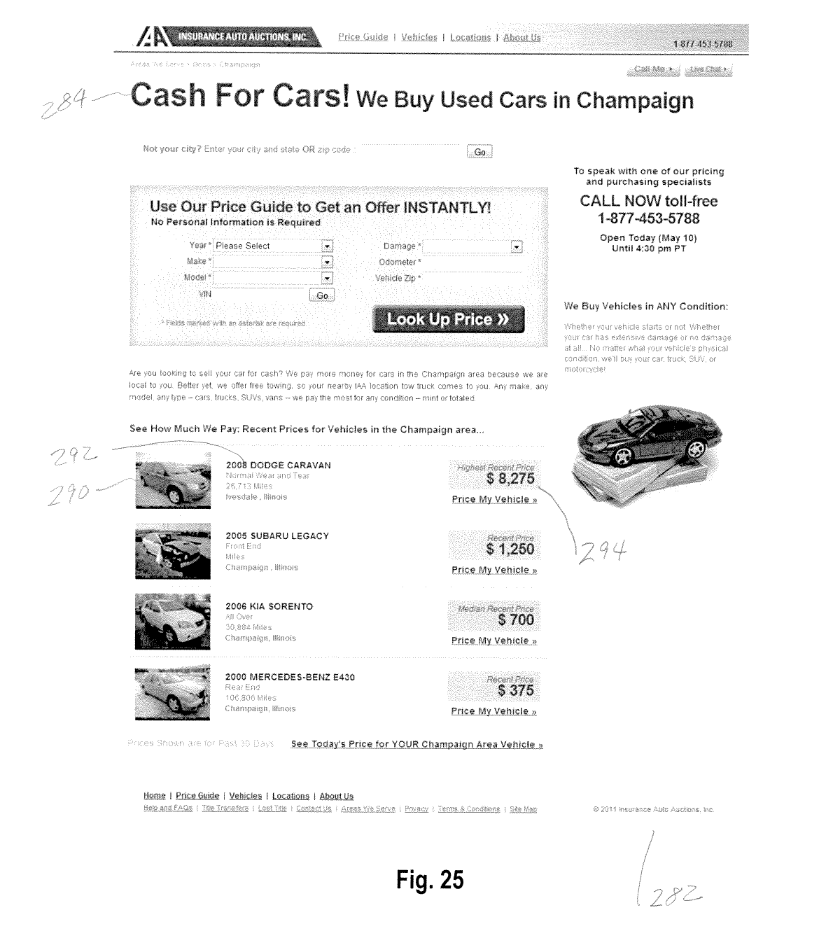

If the user selects a city on page 272 or inputs a city or postal code, the browser takes the user to page 282 as shown at FIG. 25 that indicates the selected city at 284. An algorithm in the server determines price information for vehicles in the general area of the city. The prices are shown to the user by thumbnail images 290 that include a vehicle description 292 and a price 294. A plurality of vehicles purchased in the general area of the city are shown along with their prices and other information. The user thus has an idea of the company's willingness to serve the general area of the city.

FIG. 26 shows other entry pages for access to the present method, including a page 296. This page is reached by selection of the “about us” link 226 that appears on many of the pages. The page 296 tells the user about the company business of purchasing used or damaged vehicles 298, gives location information for the company locations 300, and includes an information entry block 302 into which information is entered by the user, after which the user selects the “make me an offer” button 304 to take the browser of the user's computer to page 184 in FIG. 17.

FIG. 27 shows a page 306 that is reached by a user selecting the “locations” link 224 that appears on many pages. The locations page 306 emphasizes that the company is a local buyer of vehicles and highlights a location thought to be near the user by displaying an address 308 of a nearby location, showing a map 310 of the nearby location and showing images 312 of vehicles towed to the company location near the user. An algorithm on the server determines the company location to show the user and presents the address and map information as well as selects the images of the vehicles towed to that location. An information entry block 314 is provided.

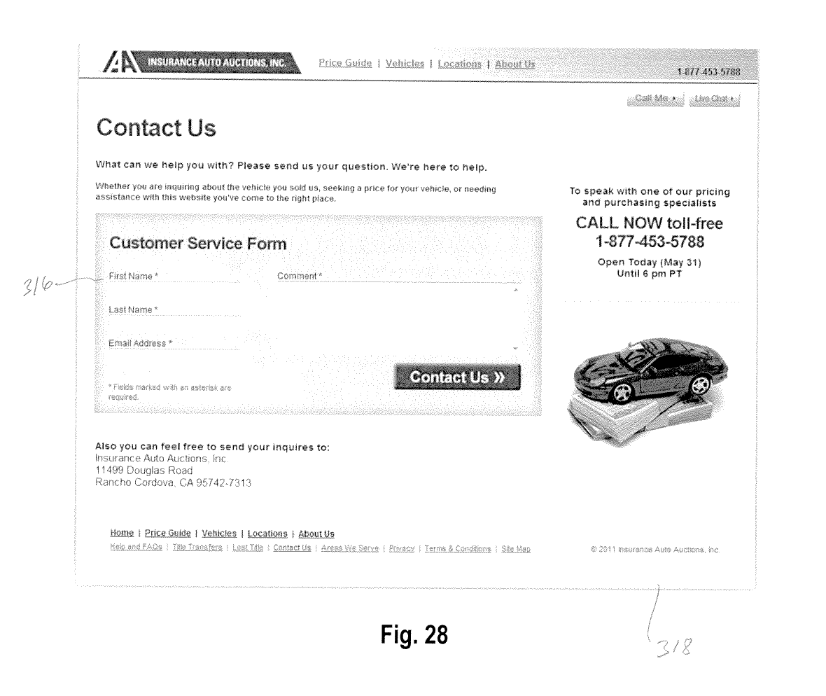

In FIG. 28, the user may provide feedback to the company by a customer service form 316 on page 318.

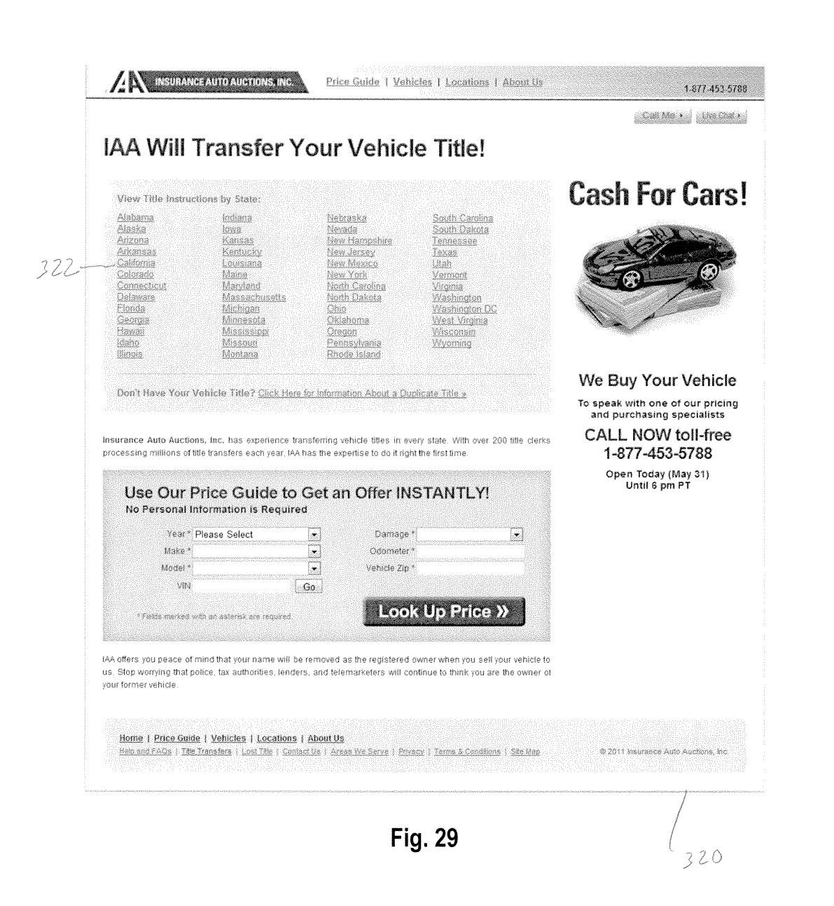

The purchase of the vehicle by the company from the user requires a transfer of the title. In FIG. 29 a page 320 is provided to inform the user that the company will transfer the title as part of the purchase. A state list 322 is provided informing the user of the states in which the company can transfer the vehicle title. The states in the list 322 are active links that take the browser to a state specific page for the title transfer.

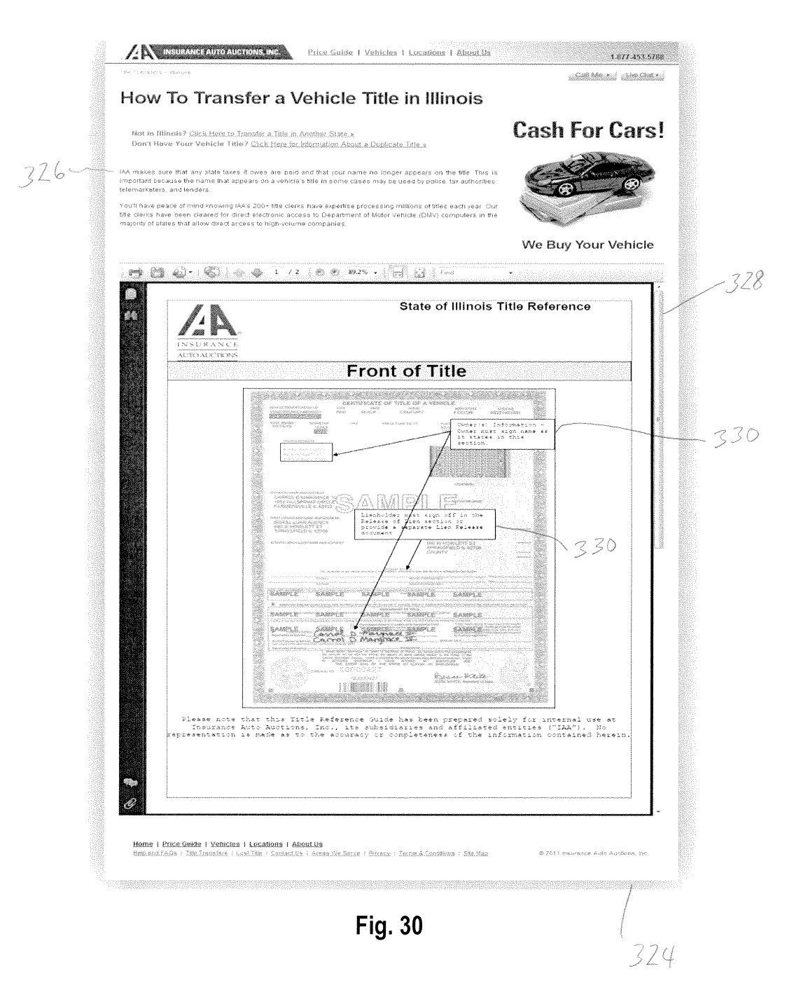

The user has selected a state from the list 322 and the browser is taken to the page 324 shown in FIG. 30. The page 324 has information 326 on how to transfer a vehicle title in the selected state, here Illinois in the illustrated example. A window 328 shows a vehicle title of the selected state with portions highlighted and labeled at 330 to inform the user of the steps that must be taken by the user to effect a title transfer.

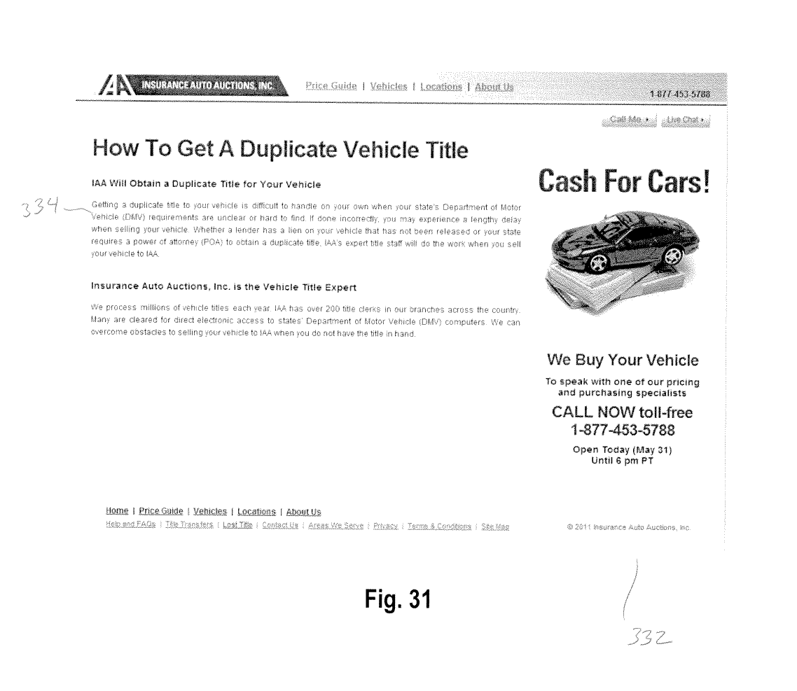

If the user has indicated that they do not have the title for the vehicle, the system takes the user's browser to a page 332 in FIG. 31. Page 332 provides the user with information 334 on how the user may obtain a duplicate title for the vehicle.

The foregoing lays out two variations of user pages for self service pricing of a used or damaged vehicle. Other layouts, arrangements and pages are possible within the scope of the present invention. The user pages may also include additional pages, including a page on the terms and conditions for use of the user site, a help page that includes answers to frequently asked questions, information on user privacy, a site map page that lays out the pages available at the user site, as well as other pages as desired.

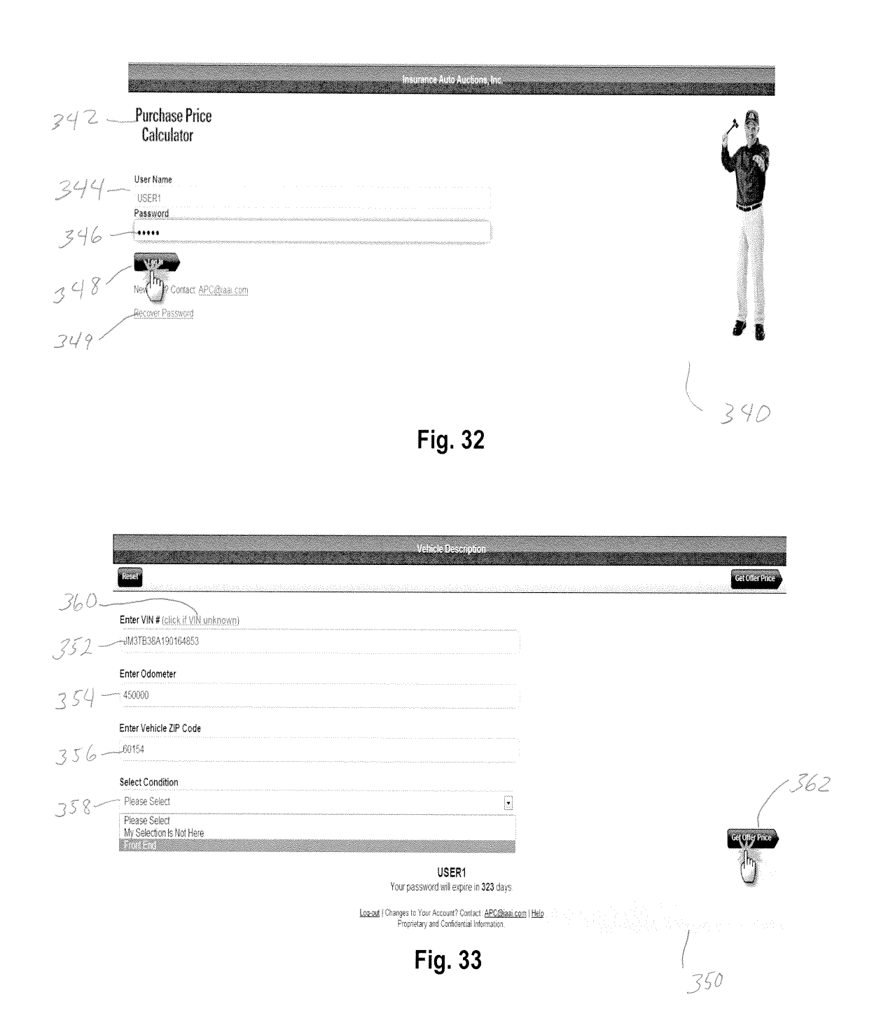

An embodiment of the present method and apparatus provides a series of web pages for use by an employee of the company who is assisting a vehicle owner in selling a used or damaged vehicle to the company. The employee user may not need as much information and guidance as the user of the self service pricing site since the employee user may be a regular user of the site and may even have had training on its use. As such, the pages for the employee user, who may be referred to as an agent, are simpler. In addition, information that helps the employee to negotiate a lower price or a lower risk price is provided. In FIG. 32, an opening page 340 of the agent or employee user site identifies it as a purchase price calculator 342. The agent embodiment on page 342 may be used in a call center that may, for example, be staffed by a number of employee agents, each with their own computer terminal in communication with the server that each run an iteration of the present price calculator. An input box 344 is provided for the user name and a box 346 is provided for the user password. After entry of the information, the user selects a log in button 348.

If the user has forgotten the user's password, a recover password link 349 is provided. Selection of the password recover link takes the browser to a series of screens (not shown) at which the user may recover their password or generate a new one, as is known in the art. In one example, the user may instruct the system to forward the password information to the user's email account.

The employee user is taken to a vehicle information entry page 350 that includes entry blocks for vehicle identification number (VIN) 352, for vehicle odometer reading 354, for the postal ZIP code 356 where the vehicle is located and for the condition 358 of the vehicle. If the vehicle identification number of the vehicle is not known, the user is instructed to select a link 360 to indicate that this information is unknown. If all of the requested information has been filed in at the page 350, the user selects a button 362 to get an offer price for the vehicle.

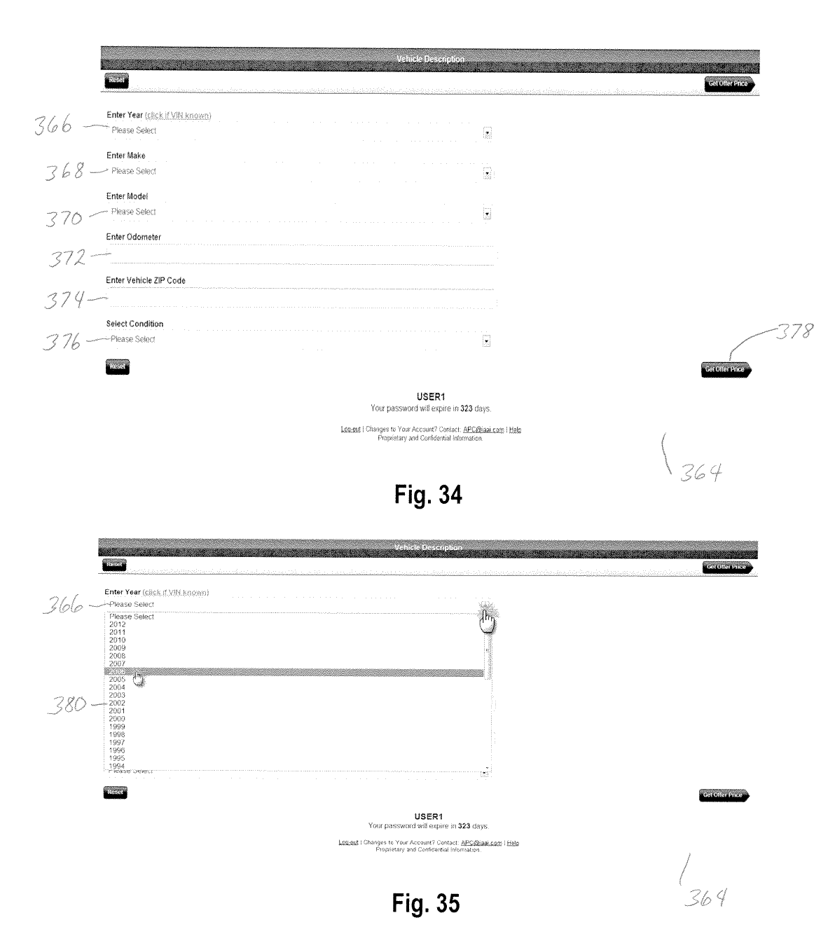

Selection of the link 360 by the user causes a window 364 as shown in FIG. 34 to open. The window 364 includes data entry blocks for entering the model year 366, make 368 and model 370 of the vehicle instead of the vehicle identification number requested on the prior page. The page 364 also includes blocks for entry of the vehicle odometer reading 372, location of the vehicle as indicated by the postal ZIP code 374, and vehicle condition 376. After completing this information, the employee user selects a button 378 to get a price for the vehicle.

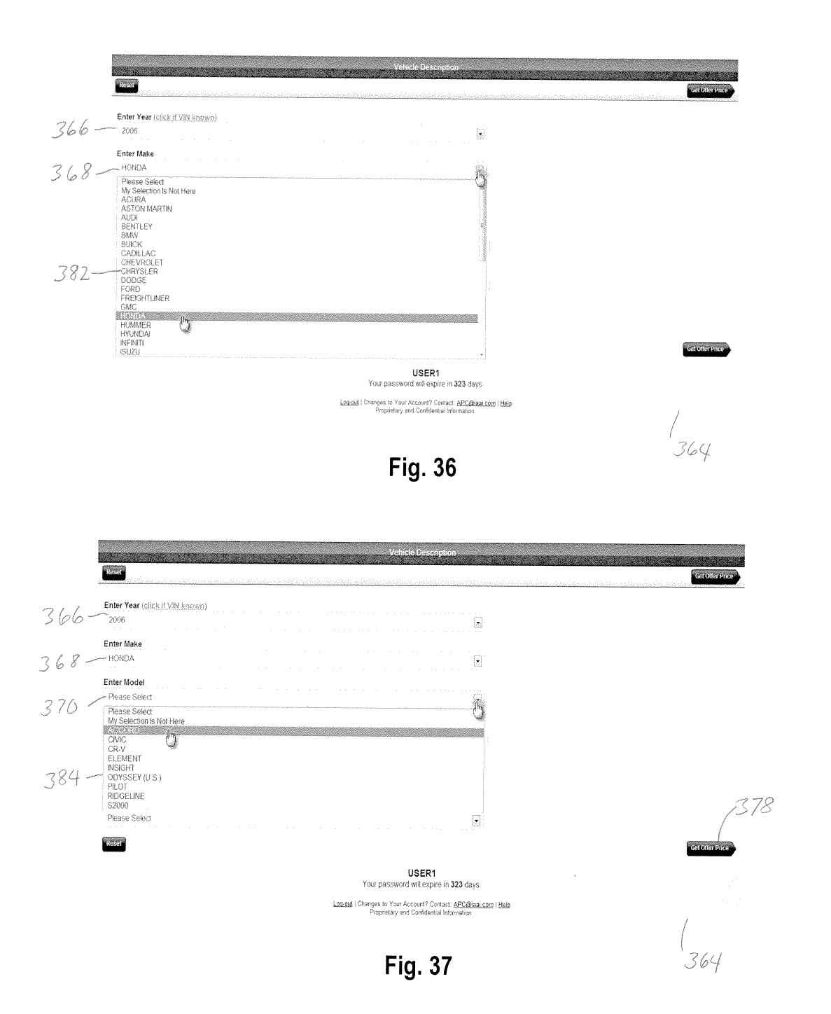

Entry of the information in the data entry blocks is preferably performed by selection of an information item from a list of possible data entries. For example, in FIG. 35 the page 364 has a pull down list 380 from which the employee user may select. The listed model years encompass those for which data is available in the database stored on the server, in a preferred embodiment. FIG. 36 shows that the vehicle make entry block 368 includes a pull down list 382 that lists manufacturers of vehicles. The listed manufacturers encompass those for which data is available in the database stored on the server, in the preferred embodiment. The user selects a make of vehicle from the list 382, which is then entered in the entry box 368. The list of vehicle makes includes only those available for the model year given in the box 366 and for which the database has information in the preferred embodiment. An algorithm in the server ensures that proper vehicle makes are listed.

In a similar manner, the page 364 has a pull down box 384 as shown in FIG. 37 which lists all the models of vehicle made by the selected manufacturer during the selected model year. The listed models encompass those for which data is available in the database stored on the server, in the preferred embodiment.

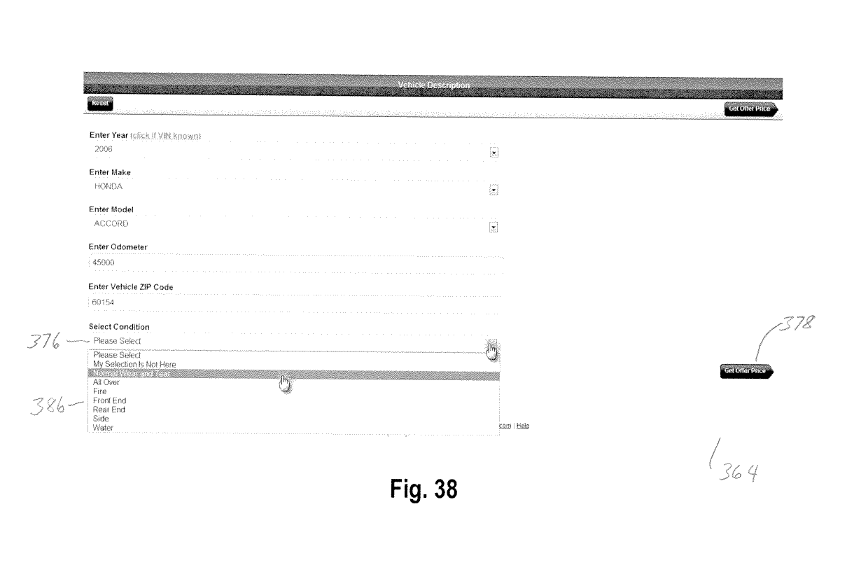

In one embodiment as shown in FIG. 38, the box 376 for entering the condition of the vehicle has a pull down list 386 from which may be selected possible conditions. The listed conditions encompass those for which data is available in the database stored on the server, in the preferred embodiment. In one example, the possible selections may include normal wear and tear, all over, fire, front end, rear end, side and water damage. Another option on the list 386 is the entry named “my selection is not here.” After entry on the page 364, the user selects the get offer price button 398.

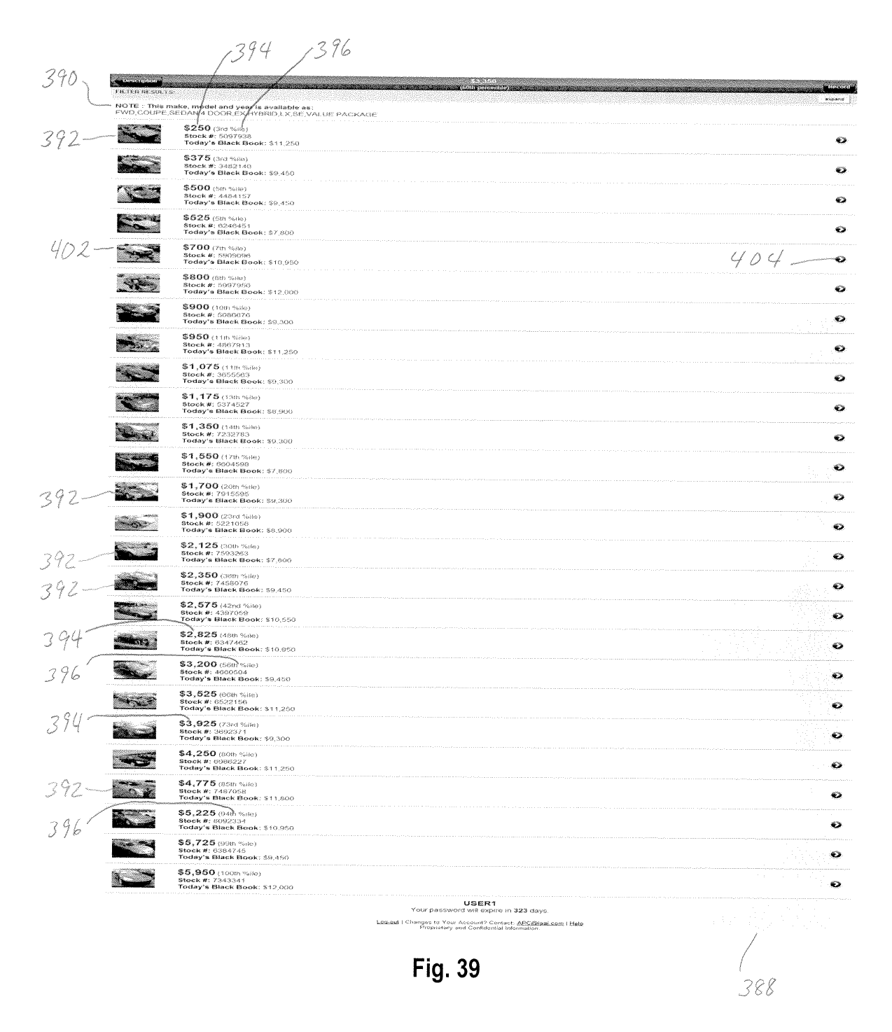

The agent or employee user has entered information in the appropriate boxes and has selected the button to get offer price. As a result, the page 388 is displayed, as shown in FIG. 39. The page 388 includes a listing of vehicles matching the description entered by the agent with a range of prices and a range of different conditions. The vehicle identified by the data entered by the agent is available with different trim levels, options and body configurations as indicated at 390. This information may help the agent ask specific questions about the vehicle, that might for example be used in determining variations in value for the vehicle model The vehicles are shown as thumbnail images 392, with each with generally less damage than the one above it. The purchase price 394 for a vehicle in about the same condition as the displayed vehicle is shown adjacent the image 392, along with a percentile number 396 that indicates to the agent the rank of that price in the dataset of prices for that postal code, odometer reading, make, model, year and condition. In the illustrated example, a 2006 Honda Accord is has been selected. The prices for this vehicle in a damaged condition range from a heavily damaged vehicle at a purchase price of $250 which is a price above only three percent of the data available for this model vehicle, through a price of $3200 for a less damaged vehicle which is a price above 56 percent of the data available for like vehicles, to a price of $5950 for a vehicle with little damage which is a price at the 100^{th} percentile of available data for this vehicle.

The price span and the price interval to be displayed is selected by an algorithm in the server. The algorithm for determining the interval between prices of vehicles shown to the user in the agent embodiment may be the same or a similar algorithm as the algorithm used for the self service pricing embodiment.

An optional feature of this embodiment is to use an algorithm for filling gaps between prices shown to the user. For example, the gap filling method described above by which vehicles may be moved by up to two price intervals to fill the gaps. This provides an improvement over use of an interpolation method or other linear gap filling technique, which may result in nonsensical results where large gaps in the available data exist.

A vehicle with a price at or nearest to the price determined to be show by the interval algorithm is selected for display. A preference may be provided in the system to show either vehicles that were obtained at either a higher price than the price interval price or at a lower price than the price interval price. The percentile information is also calculated by an algorithm in the server using the data stored in the database. For example, an algorithm determines a percentile for the price shown to the user at the top of the page. An algorithm determines a percentile for each price shown to the user. The price and percentile information permits the agent to make informed decisions about the price to be offered to the owner for the vehicle. For example, if the percentile information shows that a price is at or above the 90^{th} percentile, this price should only be offered to few if any owners for their vehicles. Other utility for the percentile information will be apparent to those of skill in the art.

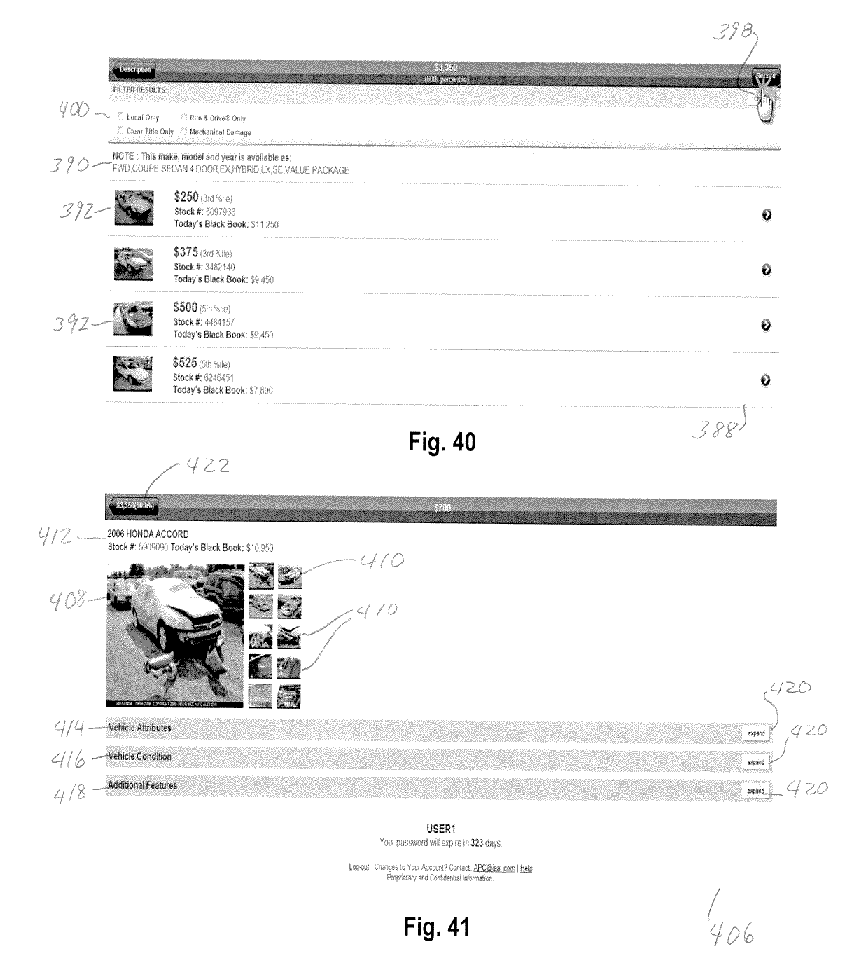

The entry of this particular vehicle has resulted in a lengthy listing, which may be burdensome for the agent or user to review, particularly if the agent is actively working with the vehicle owner. To better assist the agent, the page 388 includes a filter function to filter the displayed results. The filter is collapsed and can be expanded by an expand button 398. Upon selection of the filter button 398, the user is presented with filter choices. An example of filter choices 400 is shown in FIG. 40 as check boxes. In the illustrated example, the filter choices include local only, clear title only, run and drive only, and mechanical damage. The filters display the results of the dataset after application of the corresponding filter function. For example, the local only filter displays only vehicles that were sold in the same metropolitan area as the postal code input by the user. The mechanical damage filter causes the damage type to be applied as a filter to the dataset. For example, the selection of the mechanical damage filter when the damage type is indicated as fire will result in the removal of vehicles that are not indicated as having both mechanical damage and fire damage. By selecting one or more of these filter functions, the choices shown to the user are narrowed and provide a better range of prices to be offered to the owner.

Returning to FIG. 39, the user chooses a vehicle at a price of $700 for further review, for instance the vehicle shown at reference character 402 on page 388 as shown in FIG. 39. To see the further information on this vehicle, the user selects an arrow symbol 404 that is in the listing row with the chosen vehicle. Selection of the symbol 404 causes the browser to open a page 406 as shown in FIG. 41. The page shows a larger view 408 of the image shown in the listing along with additional thumbnail images 410 of the vehicle from different angles. Each of the thumbnail images 410 can be opened in the larger view 408 by selecting the image 410 as desired. The top of the page 406 includes the vehicle model and make information at 412. Additional information can be obtained by the user by selecting a vehicle attribute tab 414, a vehicle condition tab 416 and an additional features tab 418 by selecting an “expand” button 420 for each tab. For example, selection of the expand button 420 for the vehicle attributes tab 414 opens an information panel that includes information such as VIN number, body style, engine specifics, transmission type, drive line type, vehicle class, etc. The selection of the expand button 420 for the vehicle condition tab 416 opens an information panel that indicates for the displayed vehicle the nature of the primary and secondary damage, whether airbags are deployed, the type of damage, the odometer reading and whether a key was present, etc. Selection of the expand button 420 for the additional features tab 418 opens an information panel that indicates whether optional equipment is present, such as a radio, tape deck or CD player.

If the displayed vehicle is not in a condition comparable to the owner's vehicle, the agent user may return to the listing shown in FIG. 39 by selecting the back button 422. The user is once again shown the listing of prices and vehicles that match the make, model and model year, and the user can select a different price or different level of damage for the detailed display.

The employee user is thereby able to review the information presented on the pages and determine whether vehicle information stored in the database matches the vehicle information input by the user and to thereby determine a price that should be offered to the owner for the owner's vehicle. The employee user may disclose to the owner the price shown by the system for a vehicle in a comparable condition, or may not disclose this information. The user may disclose the percentile information to the owner, or may not. The employee user may review the agent pages with the owner so that both see the range of prices and conditions for vehicles of the type that the owner wishes to sell or may the user may keep this information from the owner. If the owner accepts the price offered for the vehicle by the agent the agent may proceed with arrangements for pickup of the vehicle, transfer of the license, arrangement for the payment, etc. either on their own or with the guidance of the present system, similar to the guidance offered by the self service pages discussed above.

If the employee user selects a vehicle type, price or condition for which the system has inadequate information to provide the price listing and detailed information, the system displays a message to the user that there is not enough examples of this vehicle in its condition to provide the user with the requested information. The user is asked to select the help function to obtain more information on how to handle the particular situation.

The help function displays to the user information on the meaning of terms displayed and assistance to the user in use of the system. Customer service hints may also be provided.

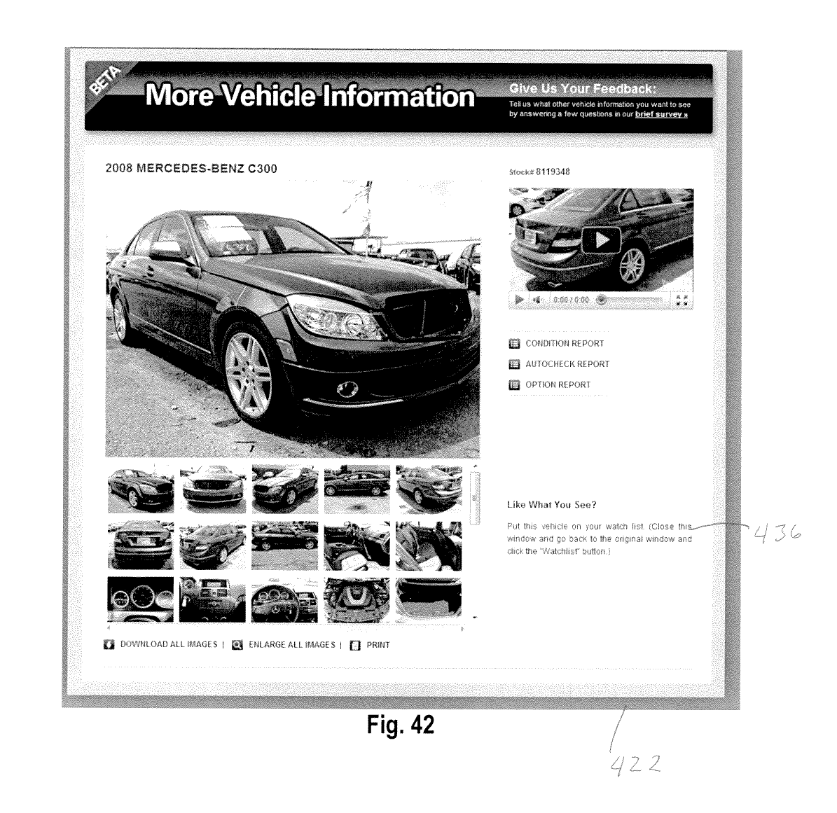

In an embodiment of the present method, a user feedback page 422 as shown in FIG. 42 is provided. The user feedback page 422 permits a user to see detailed information about a particular vehicle including a large size photograph 424, a number of small size photographs 426 that can be viewed in a large size, a video 428 of the vehicle, a condition report 430, autocheck report 432 (a vehicle history reporting service), and an option report 434. The user can select a watch list command 436 to place that vehicle or similar vehicles on the use's watch list. The user is thereby notified, for example by electronic messages such as email or text, of an impending sale of the vehicle or of the availability of similar vehicles, for example. The present method thereby enables a user to identify a vehicle or vehicle type to monitor. The user may be the seller of the vehicle or the employee user who is monitoring a particular vehicle or vehicle type.

The present method and apparatus enables the company to minimize the risk that a used or damaged vehicle that is purchased from a vehicle owner will be auctioned below the purchase price. Further, the method and apparatus provides an automated system by which purchase prices for used or damaged vehicles are obtained that build in prices obtained for comparable vehicles, regional price differences, regional overhead cost differences, changes in current prices, and a margin for profit by the company.

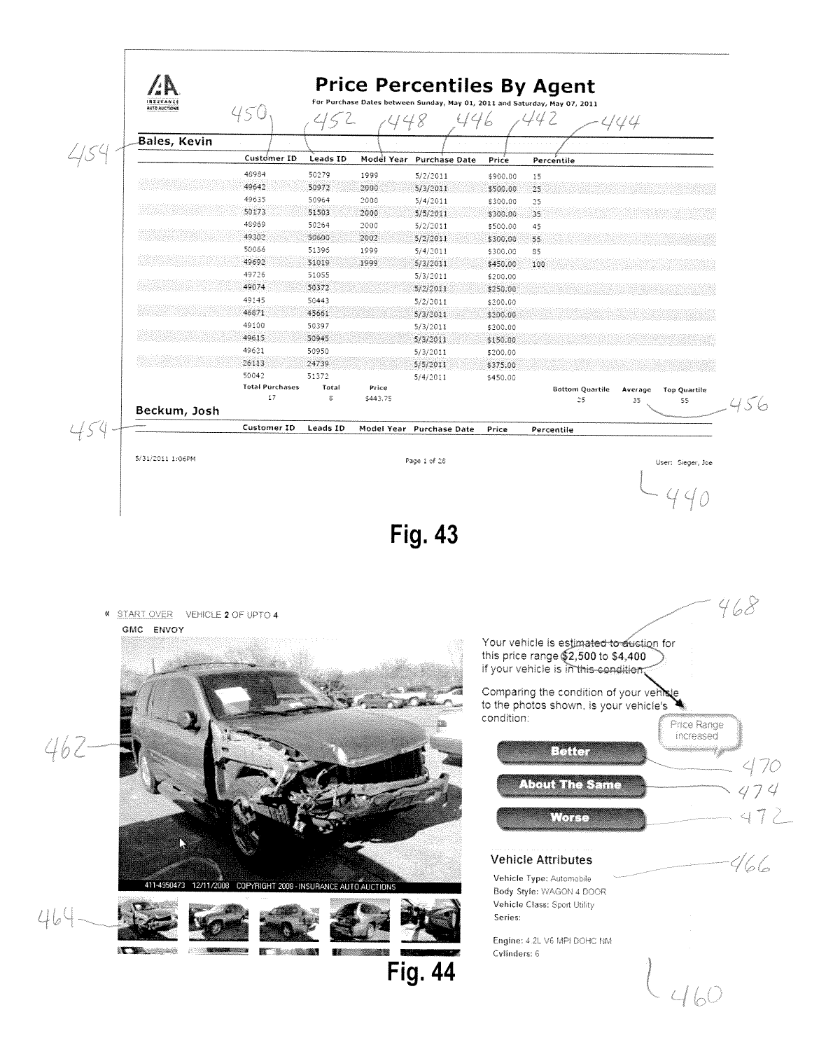

Turning to FIG. 43, an agent performance page 440 can be displayed by the present system and method by selecting the appropriate command to display the prices negotiated by a particular agent employee for vehicles purchased using the agent embodiment of the method. The agent performance page 440 tabulates the data relating to vehicle purchases by the agent and provides an analysis of the agent-specific data. The tabulated data includes the purchase price 442 and the percentile 444 of the purchase price within the span of prices paid for vehicles of that make, model and model year, along with additional information such as the purchase date 446, the model year 448 of the vehicle, a customer number 450 and a lead number 452 for each transaction. This information is sorted by agent 454 and may be displayed for each agent using the agent interface of the present method. The agent totals and averages are displayed at 456 including total purchases, average price and average and quartile percentile information.

The agent as well as company personnel are able to determine the performance of particular agents to determine, for example, if the purchases arranged by the agent are in line with purchases by other agents of the company as recorded in the database stored on the server. The agent performance page may display other statistics in addition to or instead of the percentile average information. The agent may be compensated based on the percentile information that the agent is able to obtain when making vehicle purchases. Other information obtained regarding the agent's supervised vehicle purchases may be reported and used as a factor in determining agent compensation.

The collected data may be analyzed to determine performance of groups of employees, shifts of employees, branch offices, offices in a region, or other division or grouping, or of the entire company.

The methods described above control the display of vehicles based on a price determination, in other words, the reports control for price. The input of user data linking vehicles based on comparable damage levels through the utilization of the present method and system builds a database of linked damage levels. The resulting database enables controlling for damage, for example, when displaying vehicles to users for purchase prices, for reporting performance, or for other determinations such as predicting auction price, repair costs, or other issues. The present method encompasses controlling for damage in generating output of the database for various purposes.

The report may be used for due diligence review by setting thresholds that are triggered should a percentile proposed by an agent exceed a threshold. For example, an agent may be required to seek supervisor approval for a purchase where the percentile of the purchase price is greater than the predetermined threshold. The system may automate the triggering of the approval requirement, thereby reducing risk to the company.

The present method uses human vision (e.g., viewing the photo, receiving data about the item) versus a computer (e.g., machine vision) to compare damaged vehicles. The present method an apparatus provides an application for pricing (e.g., used to set a transaction price) versus used for valuation or appraisal. The present method provides a means for a user to identify item similar to the user's item versus uncovering the location or history of the original item (e.g., someone might want to know what happened to a vehicle after witnessing a collision but they do not have it's VIN, they only remember what it looked like).

The present method and apparatus provides a database of information that is created when users indicate the condition of their items by selecting from photographs of other (e.g., damaged) items. The database may be arranged to relate one (e.g., damaged) item to another (e.g., damaged) item. This database has at least two uses. First, it can be used to help guide future users through the process of interacting with photographs. Second, it can be used to analyze and report information about items in a manner that uses damage as a comparison control (e.g., is a specific type of item with a specific amount of damage selling now for more or less than in it did in the past?).

In a further development as shown in FIG. 44, the present method provides an interface page 460 for display on a computer system that is used to determine an estimate of the price for which a vehicle can be sold at auction. The user of the auction price estimator inputs vehicle information, such as make, model, year, mileage and location as with other embodiments of the method. The computer system scans the database and identifies vehicles that have sold at auction and that match the characteristics of the user's vehicle. The page 460 is displayed on which appears an image 462 of a vehicle that generally matches the characteristics submitted by the user. Additional images 464 are available as thumbnail images which can be enlarged. Vehicle attributes 466 are shown as well as a price range 468 as an estimate for a possible price at which a vehicle in the illustrated condition might sell for at auction. The estimate is determined using the vehicle auction price information in the database which may be adjusted by various factors as already described. For example, the auction price prediction may be based on the auction price of the displayed vehicle as modified by region or location factors, time factors, title and towing factors, or other factors. Of course, the actual auction price that the user's vehicle will fetch at auction cannot be determined until the auction occurs, so the price range is an estimate. In the illustrated example, the price range is $2500 to $4400. The user is able to determine the possible auction price for their vehicle if it matches the condition of the illustrated vehicle. If the user's vehicle is in better condition or worse condition than the vehicle shown, a better button 470 and a worse button 472 is provided to take the browser program of the user's computer to a page showing either a vehicle in better condition or in worse condition, as in the earlier described embodiment. The price range estimate will go up or down depending on the changes in condition.

The user may continue selecting better or worse condition vehicles until a vehicle is found that generally matches the condition of the user's vehicle. If the user wishes to have the user's vehicle sold at auction, possibly after learning the estimated auction price, the user selects the about the same condition button 474, which takes the browser program to a contact page similar to those previously shown so that the user may arrange contact with the company to set up the auctioning of the user's vehicle. Other features such as the methods of inputting vehicle information, viewing larger images of the vehicle, views of recent vehicles auctioned, etc. noted herein may apply to this embodiment.

This embodiment may also be used by those considering attending an auction to obtain a vehicle. The user may input a desired vehicle into the system and obtain estimated auction prices for the vehicle if the vehicle should be presented for auction. A user who learns that a vehicle will be presented for auction may similarly learn the estimated auction price for the to be auctioned vehicle.

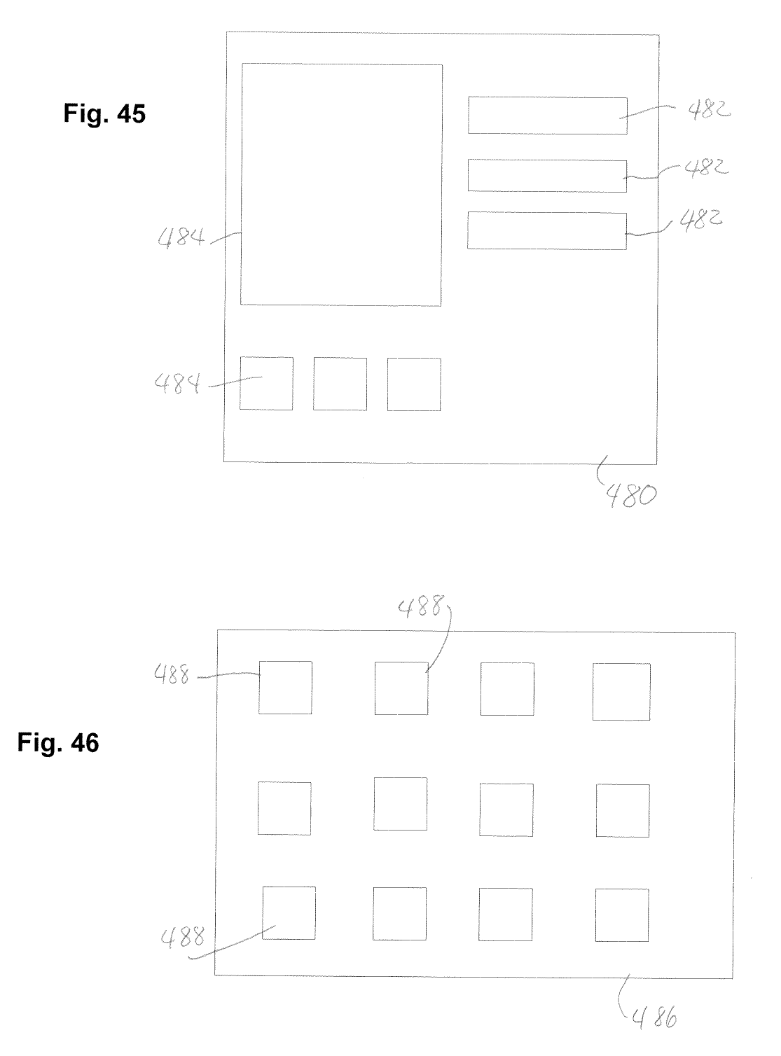

In a further embodiment shown in FIG. 45, the method and system provides a page 480 by which the user may obtain an estimate of a tax credit that may be available to the user if the user donates the user's vehicle to a charity. For instance, the user inputs the vehicle information which is used by the system to determine an estimated price or value for the vehicle and the page 480 is generated to show possible comparable vehicles and their value. Better, worse and same determinations as indicated by the blocks 482 indicate the relative condition of the users vehicle to the vehicle shown in the images 484 may be made to establish a value for a vehicle similar to the user's vehicle. The value of the vehicle is used in conjunction with the user's tax bracket information and possibly other information to determine the tax credit that the user may obtain if the vehicle is donated. The vehicle value information is determined in much the same way as with other embodiments described herein.

As yet a further embodiment of the present method as shown in FIG. 46, the system provides web pages such as web page 486 that include a sampling of vehicle purchase prices for particular vehicles or for particular cities or regions. The sampling need not be a structured price list with specified price intervals, but an example of various prices paid for the vehicle make and model. For example, the system provides a web page 486 showing images and prices 488 of a sampling of prices paid for Honda Prelude vehicles. If the user performs a search using an Internet search engine seeking to sell a used or damaged Honda Prelude, the search engine will locate the web page, permitting to user to learn of the possible prices at which the user's vehicle may be sold. A link on the vehicle page may take the user to pages of the above described embodiments at which the user may determine a sale price for the vehicle and arrange the sale.

Vehicle pages for many different vehicles are provided in this embodiment so that owners of many different vehicles can locate information for selling their vehicle.

In addition to the vehicle pages, the present method provides city and/or region pages with a similar approach as the vehicle pages. A page is generated for a particular city or region showing vehicles and prices paid for the vehicles in that city or region. The city pages show a sampling of vehicles and prices rather than a structured list. If the user performs a search using an Internet search engine seeking to sell a vehicle in the particular city or region, the search engine locates the city page so that it can be viewed by the user. The user learns of the prices available for vehicles in that city or region and may select a link taking the user to screens to arrange the sale of the vehicle.

Other key vehicle information may be used to generate other pages for location by search engines as well.

Thus, there has been shown and described a method and apparatus by which a user who wishes to sell a used or damaged vehicle inputs information about the vehicle including make, model and year. The user is shown images of similar vehicles with various degrees of damage and is shown a purchase price at each level of damage. The purchase prices for the displayed vehicles are calculated to include auction price of the vehicle, regional price differences, title transfer costs, towing costs, etc. By selecting an image of a vehicle with damage as the vehicle to be sold, the user may sell the vehicle at that price. An agent embodiment shows images, prices and percentiles of damaged vehicles at different damage levels so that the agent may determine a price to be offered to the seller for a vehicle.

Although other modifications and changes may be suggested by those skilled in the art, it is the intention of the inventors to embody within the patent warranted hereon all changes and modifications as reasonably and properly come within the scope of their contribution to the art.

I claim:

1. A method for valuing used or damaged vehicles, comprising the steps of:
receiving a user access at a computer system;
receiving a user indication of a vehicle identity of a user vehicle at the computer system;
displaying an image of a vehicle corresponding to the vehicle identity, the displayed image showing a vehicle with a degree of damage, the displayed image being displayed on a display device connected to the computer system;
receiving an input from the user as to whether the user vehicle has less damage or more damage than the degree of damage shown in the displayed image, the input being received by the computer system; and
determining a price for a damaged vehicle from the user input, the price determination being performed by the computer system;
transmitting the price to the user from the computer system.

2. A method as claimed in claim 1, wherein said displayed image is a first displayed image and said degree of damage is a first degree of damage, and further comprising the steps of:
after said step of receiving the input from the user as to whether the user vehicle has less damage or more damage than the first degree of damage shown in the first displayed image, displaying a second image of a vehicle having a second degree of damage that is different than said first degree of damage; and
receiving an input from the user as to whether the user vehicle has less damage or more damage than the second degree of damage shown in the second image.

3. A method as claimed in claim 2, wherein the second image shows a vehicle having a lesser degree of damage than the vehicle shown in the first image if the user indicates that the user vehicle has less damage than the first image; and
wherein said second image shows a vehicle having a greater degree of damage than the vehicle shown in the first image if the user indicates that the user vehicle has more damage than the first image.

4. A method as claimed in claim 1, further comprising the step of:
receiving a user input that a vehicle shown in the displayed image has about a same degree of damage as said user vehicle.

5. A method as claimed in claim 1, wherein the user indication of the vehicle identity includes a vehicle make and model year and wherein the vehicle shown in the displayed image is approximately the make and model year of the user indication.

6. A method as claimed in claim 1, wherein the user indication of the vehicle identity includes a vehicle identification number of the user vehicle.

7. A method as claimed in claim 1, wherein said step of displaying the image of the vehicle corresponding to the vehicle identity includes the step of:
obtaining the image for display from a database of images of damaged vehicles, said database including an indication of vehicle identity and a degree of damage for the images of the damaged vehicles.

8. A method as claimed in claim 7, wherein said database includes images of a plurality of different vehicle models, said database including images showing a plurality of different degrees of damage for each of a predetermined number of different vehicle models.

9. A method as claimed in claim 1, wherein the user accesses the computer system over the Internet.

10. A method as claimed in claim 9, wherein said user accesses the computer system via the World Wide Web.

11. A method as claimed in claim 1, wherein the computer system receives an indication from the user of a location of the user.

12. A method as claimed in claim 1, further comprising at step of:
receiving a user indication of damage to the user vehicle.

13. A method as claimed in claim 12, wherein said user indication of damage includes at least one item of information selected from the set of information consisting of: an identification of a cause of damage, an identification of a location of the vehicle of the damage, and an operating condition of the vehicle,

14. A method as claimed in claim 1, wherein the user identification of the user vehicle includes indicating possession of a key for the vehicle, indicating possession of ownership documents, whether the vehicle can start, and whether the vehicle can be driven.

15. A method as claimed in claim 1, further comprising the step of:
arranging pick-up of the user vehicle after the determination of the price.

16. A method as claimed in claim 1, further comprising the step of:
transmitting a confirmation to the user of determinations obtained.

17. A method as claimed in claim 1, wherein said determining the price of the vehicle includes:
determining an auction price of an illustrated vehicle;
factoring into the auction price at least one of: time factors, regional price factors, title transfer costs, and towing costs based on user input to obtain a modified auction price; and
including a margin with the modified auction price to obtain the price shown to the user.

18. A method for valuing used or damaged vehicles, comprising the steps of:
receiving a user access at a computer system;
receiving a user indication of a vehicle identity of a vehicle to be sold, said vehicle identity being received at the computer system;
calculating purchase prices for a plurality of vehicles sharing characteristics with the vehicle to be sold, said plurality of vehicles having differing levels of damage, said calculating step being performed by the computer system;
displaying images of a plurality of vehicles sharing characteristics with the vehicle to be sold, said images showing vehicles having differing levels of damage, the displayed images being displayed on a display device connected to the computer system;
displaying the purchase prices for the plurality of vehicles, said purchase prices being at price intervals within a price span, the purchase prices corresponding generally to a level of damage of the corresponding vehicle, the displayed purchase prices being displayed on the display device connected to the computer system; and
receiving a selection from the user of a vehicle corresponding to a damage level of the vehicle to be sold, the selection being a selection of at least one of a displayed vehicle and displayed purchase price, the selection being received by the computer system.

19. A method as claimed in claim 18, wherein said displayed images and said displayed purchase prices are displayed to a user seeking to sell the vehicle to be sold, and further comprising:
transmitting information to the user to arrange for purchase of the vehicle to be sold after said selection from the user.

20. A method as claimed in claim 18, wherein said displayed images and said displayed purchase prices are displayed to an agent; and further comprising:
displaying percentile information for each displayed purchase price.

21. A method as claimed in claim 18, wherein said step of calculating purchase prices for a plurality of vehicles includes the steps of:
determining an auction price of each vehicle;
factoring into the auction price at least one of: time factors, regional price factors, title transfer costs, and towing costs based on user input to obtain a modified auction price for each vehicle; and
including a margin with the modified auction price to obtain the price shown to the user for each vehicle.

22. An apparatus for determining a value of a used or damaged vehicle, comprising:
a computer system having a user input and a display, the computer system being programmed by a computer program stored on a non-transitory tangible computer readable media, the computer program operating a processor of the computer system to perform the steps of:
receiving a user access at a computer system;
receiving a user indication of a vehicle identity of a user vehicle at the computer system;
displaying an image of a vehicle corresponding to the vehicle identity, the displayed image showing a vehicle with a degree of damage, the displayed image being displayed on a display device connected to the computer system;
determining a price for the displayed vehicle from the user input, the price determination being performed by the computer system;
displaying the determined price to the user;
receiving an input from the user that the user vehicle has about a same level of damage as the displayed vehicle, the input being received by the computer system.

23. An apparatus as claimed in claim 22, wherein said computer system is programmed to calculate and simultaneously display a plurality of prices for a plurality of vehicles spanning a range of prices.
